(19) United States
(12) Patent Application Publication
(10) Pub. No.: US 2025/0361649 A1
(43) Pub. Date: Nov. 27, 2025

(54) Microdecortication and densification of hemp fiber manufacturing and its application in polymer composites

(71) Applicant: TANGHO GREEN HOLDING INC., Newark, DE (US)

(72) Inventors: Leonardo Coelho SIMON, Newark, DE (US); Douglas CASETTA, Newark, DE (US); Franciele TURBIANI, Newark, DE (US); Gulzeb Khan KHAKWANI, Newark, DE (US)

(73) Assignee: TANGHO GREEN HOLDING INC., Newark, DE (US)

(21) Appl. No.: 18/673,193

(22) Filed: May 23, 2024

(51) Int. Cl. D01B 1/14; C08L 23/12; D04H 1/413; D04H 1/425; D04H 1/4382; D04H 1/44

(52) U.S. Cl. CPC D01B 1/14; C08L 23/12; D04H 1/413; D04H 1/425; D04H 1/43835; D04H 1/44; C08L 2205/16; D10B 2401/063; D10B 2505/02

(57) ABSTRACT

Disclosed are methods for the direct production of short fibers using microdecortication processes and the production of densified particles and short fiber products, sourced from hemp or other bast plants, hemp fiber products, methods for the production of hemp fiber-reinforced polymeric materials, and the polymeric materials resulting therefrom. An embodiment of the method for the production of densified hemp fiber products involves microdecortication with the utilization of particle size reduction equipment to cut all or a portion of hemp stalk, bast fiber, and hurd to produce short fibers and particles. Some embodiments make use of microdecortication to cut whole hemp stalk directly into short hemp fiber. Equipment with cutting action may provide for more adequate control of fiber size and aspect ratio while using the whole hemp stalk to produce short fibers, as opposed to the production of short hemp fibers by cutting long hemp fibers originating from decortication.

### FIELD

The embodiments relate to sustainable materials, advanced manufacturing thereof, and the development of hemp polymer composites. One embodiment includes a method for manufacturing densified, short hemp fibers with controlled sizes in which hemp fibers may be subjected to pelletization, resulting in the creation of hemp pellets with a unique balance of properties. In some embodiments, the hemp pellets are useful in polymer composites, and have improved handling, storage, and feeding in industrial machines, while being highly desirable particularly when combined with polymers to produce hemp polymer composites with enhanced performance and renewable content. The embodiments enhance not only the material properties but also the practical aspects of incorporating hemp into various industrial processes.

### BACKGROUND

Natural fiber incorporation into polymer matrices is a well-established technology for improving the mechanical properties and environmental performance and desirability of composite materials. Hemp is one of the most promising natural fibers due to its exceptional strength, low density, annual availability and eco-friendliness. Traditionally, hemp stalks were transformed into long fibers using hammer mills, resulting in long fibers with limited size variability. Decortication is a known process for removing long fibers with lengths longer than 5 centimeters, but preferably longer than 10 centimeters, along with hurd. The length of the fibers can be an important characteristic controlling the mechanism of entanglements required in the manufacturing of fabrics or non-woven mats. Short fibers with lengths less than 2 centimeters usually do not posses the characteristics required to provide entanglement, and consequently they are not a desirable product of common decortication technology.

An element of the decortication technology is the use of equipment that can remove the fiber without reducing their length, thus creating long fibers. This can be accomplished by selecting equipment that does not cut the fiber, but instead crushes the stalk to extract the long fibers without reducing the length of the fibers. A hammer mill is commonly used because the element of impact can crush the stalk without cutting the fiber, thus enabling the extraction of the fibers without reducing their length. Other methods of removing long fibers from hemp include roller mills, ball mills, manual beating, and the like to break the feedstock and liberate the long fiber from the stalk, without cutting the fiber. There is a need for improved technologies in the field of hemp polymer composites, given the growing demand for sustainable and biodegradable materials.

Industrial hemp is known to provide long fibers with excellent properties. Other plants that produce similar long fibers are jute, flax, kenaf and sisal. The main process for producing long fibers is known as decortication. The resulting products in the commercial decortication of hemp are long fibers, hurd and dust. Long hemp fibers are also referred to as bast fiber, whereas long sisal fibers are leaf fibers. These long fibers find extensive applications in producing fabrics, non-woven mats and twines, which can then be used for a variety of applications like composites, insulation, absorbents, textiles and ropes for example. A key characteristic of the products of those processes is the fact that long fibers can be weaved or entangled to produce two- and three-dimensional structures. In addition to hemp, other examples of bast fibers can include, but are not limited to, flax, jute, kenaf, and ramie.

In applications requiring short fibers, the long fibers produced by decortication can be cut to the desirable length. For example, short fibers can be used to reinforce plastics useful for injection molding and other polymer processes such as extrusion and the like. Usually, the resin, fillers, fibers and additives are compounded in extruders forming plastic pellets having a formulation that satisfies the final performance characteristics for the end products made from the pellets. These plastic pellets produced by extrusion compounding can be shaped into final goods or parts using injection molding for the formation of films or sheets. These plastic pellets often have a diameter of approximately 3-5 millimeters and length of 3-5 millimeters, but sometimes the length of the plastic pellets can be longer. It is unusual, however, for plastics pellets to be longer than 2 centimeters.

At present, a common technique for producing short fibers with lengths less than 1 centimeter involves two steps: (i) the extraction of long fibers with lengths longer than 10 centimeters possibility originating from a decortication process; and (ii) cutting those long fibers to a desirable length of less than 10 centimeters.

Another technology involved in processing hemp fibers includes particle size enlargement or densification. In many fields it is desirable to increase the particle size or to increase the bulk density of materials. A common process to achieve such goal is the use of pellet mills, for example, a pellet mill from company Colorado Mill Equipment. In this type of equipment, material with small particle size, powder, crumbles, or flakes are forced through a die or orifice by aid of mechanical forces. The increased pressure experienced by the material inside the die leads to the creation of forces that hold the material together when it exists the die. The diameter of such pellets is mostly controlled by the diameter of the die, while the length of such pellets is controlled by the ratio between rate of which the material leaves the die and the rate at which the material is cut or broken after exiting the die. The pressure inside the die can be controlled to some extent by the die geometry and feed rate. Other parameters that affect the characteristics of the pellet are temperature, moisture, binding agents, size, geometry, and properties of the particles in the feed. Increasing the pressure during pelletization leads to the production of pellets with low pellet porosity and increased pellet strength. This is desirable, for example, in the manufacture of energy pellets using saw dust or by-products of agriculture. Energy pellets are used to feed combustion processes and generate energy. The quality of the energy pellets can be measured by their specific energy and durability.

Pellets with high durability are desirable because they do not disintegrate, crumble, break or generate fines during handling, transportation or storage. The durability of pellets is associated with their high compressive, flexural and impact strength. Although pellets with high strength are desirable for energy applications, they are not suitable for manufacturing polymer composites because the pellets with high strength are difficult to disperse in polymer matrices using conventional polymer mixing equipment such as extruders. The inability to properly break down the pellets reducing the particle size and to disperse pellets with high strength inside the polymer matrix during processing in an extruder leads to poor dispersion of particles inside the polymer matrix, and the resulting polymer composites have undesirable mechanical performance. Hence, energy pellets are considered inapt for dispersion in polymers leading to polymer composites with desirable properties.

There is an increasing need for reinforcing polymer composites with short fibers and for improving the properties of the reinforced plastic (polymer) composites. Plastic composites reinforced with glass fiber, basalt fiber, synthetic fiber, or with natural fiber can have mechanical properties that are highly desirable in a variety of applications. For example, fiber reinforced polymer composites can reduce the weight of vehicles, which in turn would require less energy for transportation. There currently are few if any suitable technologies for directly producing short fibers or processes for densification of short fibers that would be useful in enhancing the performance of polymer composites. The embodiments described herein address these and other needs that will be readily apparent to those having ordinary skill in the art, including but not limited to the following:
Lack of processes for producing short fibers;
Lack of densified short fibers suitable for polymer composite manufacturing; and
Lack of short fibers with composition, length, and aspect ratio suitable for densification and enhancing the physical properties of polymer composites.

### SUMMARY

The embodiments include methods for producing short hemp fibers with controlled characteristics, and the subsequent densification of those fibers making them highly desirable for producing hemp polymer composites. The embodiments described herein also include hemp fiber compositions and polymeric composite materials made therefrom.

One embodiment includes processing hemp stalk directly into short fibers by cutting the hemp stalk into fibers having a length of less than about 2 centimeters (2 cm) using a microdecortication process. One way of achieving this is by utilizing a cutting apparatus such as a knife mill to reduce the particle size of hemp stalk. This approach provides advantages that originate from its differences from the traditional decortication process based on the use of hammer mills employed to produce long fibers. This embodiment enables greater control and precision over the length and aspect ratio during the direct manufacturing of the short fibers. In an embodiment, reducing the length of hemp stalks does not include decortication.

The embodiments therefore relate to cutting, or microdecorticating hemp fibers to a desirable length (i.e., less than about 2 cm), to process whole hemp stalks and directly produce fibers with lengths preferably less than about 1 cm, and with a greater control over fiber composition, fiber length and aspect ratio.

Another embodiment includes densifying the reduced sized hemp stalks, bast, and hurd to increase the bulk density of the short fibers containing a wide range of sizes and aspect ratios. The densification can be achieved by selecting stalk and fiber characteristics and the type of equipment to achieve these characteristics. Use of a pellet mill with selected types of short fibers can transform these loose fibers, originally possessing low bulk density, into compact fiber pellets containing a balance of properties that are highly desirable in polymer composites manufacturing. Some of these properties include the ability to display high bulk density, strength to achieve high durability while allowing suitable dispersion of the fiber pellet within a polymer matrix using conventional polymer mixing equipment, like a polymer extruder but not limited to such equipment, and generating a significant enhancement of mechanical properties of the polymer composite reinforced with such short fibers, when compared to polymer matrices that do not include such short fibers or pellets made from the embodiments described herein.

Densifying the stalk, bast, and hurd fibers having fiber lengths of less than about 2 cm into compressed pellets, cylinders or discs offers substantial advantages, when compared to loose fibers. Some of these advantages include, but are not limited to, improved handling, storage, and feeding into industrial machines such as driers, conveyers, metering and packaging equipment, mixers and extruders, allowing for improved blending with polymers to create hemp-reinforced polymer composites. Processing the short hemp fibers in this manner not only improves material qualities for polymer composites, but also streamlines industrial operations, marking a significant advantage when compared to the use of loose fibers in the industry.

The densification of processed short hemp fibers provides additional advantages insofar as it opens up additional avenues for hemp utilization in industrial applications. The methods described herein greatly enhance the handling, storage, and feeding of these materials into industrial machinery by transforming loose fibers into compact, easily handled hemp pellets, especially when mixed with polymers to produce composites. This advancement represents an important change from the industry's typical use of loose fibers and provides significant benefits in terms of operational efficiency and ease of use.

One embodiment includes a method of densifying hemp fibers suitable for reinforcing polymeric materials, including:
a) providing a quantity of hemp stalks;
b) separating a portion of the quantity of hemp stalks to provide first and a second quantities of hemp stalks;
c) subjecting a first portion of hemp stalks to decortication to produce bast fibers, hurd fibers, and dust, removing a substantial portion of dust, and separating the bast fibers and hurd fibers to produce a bast fiber portion and a hurd fiber portion. The method also includes
d) mixing the bast fiber portion, the hurd fiber portion, and a second portion of hemp stalks in any proportion to provide a hemp mixture, such hemp mixture can also be comprised of pure portions or bast fiber, hurd fiber or hemp stalks;
e) cutting or microdecorticating the hemp mixture to provide a mixture of hemp fibers and particles having a length of from about 1 mm to about 20 mm, wherein the aspect ratio of the bast fibers is from about 1 to about 250 or higher, and the aspect ratio of the hurd fibers is from about 1 to about 40; and
f) compressing or densifying the mixture of hemp fibers and particles, and optional additives to form densified hemp products.

In an embodiment, the densified hemp products are in the form of compressed pellets, cylinders, spheres, or discs, and/or the quantity of hemp stalks is provided from genetic strains of the Cannabis sativa plant. In some embodiments, cutting or microdecorticating the hemp mixture includes subjecting the hemp mixture to cutting, for example with a knife mill having sieves with openings within the range of from about 1 mm to about 5 mm.

In another embodiment, compressing the mixture of hemp fibers and particles takes place in a pelletizer at a temperature within the range of from about 25° C. to about 100° C. or higher, but preferably not above 200° C. An embodiment includes a pelletizer having a die opening within the range of from about 3 mm to about 5 mm or higher, but smaller than 13 mm in diameter. In an embodiment, one or more binders are added in an amount within the range of from about 0.01% to about 30% by weight of the densified hemp products during the compressing process. Other additives can optionally be added to the mixture that aid in the formation of suitable pellets, and/or aid in dispersion of the hemp pellets in a downstream hemp fiber-reinforced polymeric material production process.

Another feature of an embodiment includes a method of forming a hemp fiber-reinforced polymeric material comprising:
a) mixing the densified hemp product prepared by the method above with one or more polymers, and optional additives;
b) heating the mixture of (a) while mixing to disperse the densified hemp product into the one or more polymers and provide a substantially uniformly dispersed mixture of hemp fibers and one or more polymers;
c) and cooling the substantially uniformly dispersed mixture of hemp fibers and one or more polymers to form a hemp fiber-reinforced polymeric material.

In an embodiment, the amount of densified hemp product in the hemp fiber-reinforced polymeric material is within the range of from about 5% to about 30% by weight. In another embodiment, the method of forming a hemp fiber-reinforced polymeric material further includes adding one or more odor-neutralizing additives in a) and/or b) above, wherein the one or more odor-neutralizing additives is present in an amount of from about 0.5% to about 10% by weight. In yet another embodiment, heating is carried out at a temperature within the range of from about 140° C. to about 230° C.

Another feature of the embodiments includes a densified hemp product having a bulk density within the range of from about 0.1 to about 0.6 g/cm³, the densified hemp product comprised of:
a) bast fibers having a length of from about 1 mm to about 20 mm and an aspect ratio of from about 1 to about 250;
b) hurd fibers having a length of from about 1 mm to about 6 mm and an aspect ratio of from about 1 to about 40;
c) whole hemp stalk particles having a length of from about 1 to about 20 mm; and
d) optional additives.

In an embodiment, the amount of bast fibers ranges from about 20 to about 60% by weight of the densified hemp product, the amount of hurd fibers ranges from about 10 to about 30% by weight, and the amount of whole hemp stalk particles ranges from about 30% to about 50% by weight.

Another feature of the embodiments includes a hemp fiber-reinforced polymeric material comprising:
a) from about 5% to about 30% by weight of the densified hemp product described above;
b) from about 70% to about 95% by weight of one or more polymers; and
c) optional additives, wherein the hemp-fiber reinforced polymer material has a flexural strength of from about 8% to about 45% higher than the flexural strength of the one or more polymers without the densified hemp product, and a flexural modulus of from about 35% to about 100% higher than the flexural modulus of the one or more polymers without the densified hemp product.

The densified hemp product in an embodiment includes one or more additives that are useful in assisting in the formation of suitable pellets by assisting in forming a compressed mass of hemp fibers that can be dispersed in a polymeric material when forming a polymer composite material. Some examples of suitable additives include waxes (natural, semi-synthetic, synthetic), greases, fats, oils, and other similar materials. The hemp fiber-reinforced polymer material in another embodiment includes one or more polymers having a melting point below about 250° C. to avoid heating the mixture of densified hemp products and selected polymer at a temperature and for a period of time that degrades the hemp fiber. Some examples of suitable polymers include one or more selected from the group consisting of polyolefins, polyamides such as Nylon 11 and 12, which have lower melting points than Nylon 6 grades, polyesters, polyphenylene oxides, acrylonitrile butadiene styrene, polyacetal, polyacrylic acid, polystyrene, polyvinyl chloride, and mixtures and combinations thereof. These polymers are commercially available in various grades, and with various additives added thereto that can affect their respective melting temperatures, as would be appreciated by those skilled in the art.

The embodiments provide composite materials that offer both sustainability and practicality, as well as suitability for applications in industries ranging from automotive to construction and beyond. In this context, it is important to emphasize that the scope of the invention extends beyond the specific embodiments presented in the accompanying description and depicted in the illustrations. Consequently, it should be acknowledged that numerous alterations and adaptations can be implemented while remaining within the fundamental principles of the entire disclosure.

The embodiments described herein provides hemp polymer composites that strike a suitable balance between the sustainable properties of hemp and the practical requirements of industrial production processes. They can be used in a variety of industries such as automobile parts, construction materials, packaging, and consumer items. These and other embodiments will be readily apparent to those skilled in the art upon review of the entire disclosure.

### BRIEF DESCRIPTION OF THE DRAWINGS

Referring to the description provided below, along with the attached drawings will assist those skilled in the art in appreciating the features, embodiments, and objectives described herein.

FIG. 1 illustrates a preferred microdecortication process for producing short fibers.

FIG. 2 illustrates a preferred process for producing short fibers with microdecortication and pellets with densification.

FIG. 3 shows the particle size distribution of short fibers produced from whole hemp, bast fiber and hurd using three configurations (sieve sizes 1 mm, 1.5 mm and 3 mm) on the particle size reduction knife mill equipment.

FIG. 4 provides bi-dimensional characterization of particle size (length) and aspect ratio measured using optical microscopy for short fibers produced by cutting or microdecortication using bast fiber and hurd.

FIG. 5 shows the specific compressive strength of pellets produced with mixtures of short fibers, and with and without additive (wax).

FIG. 6 illustrates the bulk density of pellets produced with mixture of short fibers with and without additive (wax).

FIG. 7 depicts the bulk density of pellets produced with short fibers using hurd as feedstock.

FIG. 8 illustrates the bulk density of pellets produced with short fibers using mixtures of bast fiber and hurd as feedstock.

FIG. 9 illustrates the short fiber size distribution (length): (a) before pelletization; and (b) after pelletization for pellets produced with short fiber from hurd as feedstock.

FIG. 10 illustrates the aspect ratio distribution: (a) before pelletization; and (b) after pelletization for pellets produced with short fiber from hurd as feedstock.

FIG. 11 illustrates a preferred process used to produce hemp fiber-reinforced polymer composite materials.

In the drawings, embodiments are illustrated by way of example. It is to be expressly understood that the description and drawings are only for the purpose of illustration and as an aid to understanding and are not intended as describing the accurate performance and behavior of embodiments or limiting the scope of the features and embodiments described herein.

### DESCRIPTION OF THE EMBODIMENTS

As used herein, the terms “a” or “an” are used, as is common in patent documents, to include one or more than one independent of any other instances or usages of “at least one” or “one or more.” As used herein, the term “about” refers to an amount that is approximately, nearly, almost, or in the vicinity of being equal to or is equal to a stated amount. As used herein, the term “neat” refers to a polymer in the state as it exits a polymerization reaction chamber when it is an essentially pure polymer without any additives. As used herein, a percentage expressed as % (w/w) means percent by mass, and a percentage expressed as % (v/v) means percent by volume.

When numerical ranges of values are disclosed, such ranges are intended to include the numbers themselves and any sub-range between them. This range may be integral or continuous between and including the end values.

As used herein, the term “comprising” is intended to mean that the compositions and methods include the recited elements, but not excluding others. The term “consisting essentially of,” as applied to the compositions of the present embodiments, means the composition can contain additional elements as long as the additional elements do not materially alter the composition. The term “materially altered,” as applied to a composition, refers to an increase or decrease in the advantageous properties of the composition as compared to the properties of a composition consisting of the recited elements. In other words, “consisting essentially of” when used to define compositions, shall mean excluding other components of any essential significance to the composition. Thus, a composition consisting essentially of the components as defined herein would not exclude trace contaminants, or inert additives. “Consisting of” shall mean excluding more than trace elements of other ingredients and substantial method steps for making the compositions herein. Embodiments defined by each of these transition terms are within the scope of the embodiments.

This disclosure provides methods for directly producing short hemp fibers and pellets, and addresses fundamental challenges in the utilization of long hemp fibers in a variety of industrial applications. The embodiments present an approach that combines the use of a microdecortication process that includes a cutting device, such as a knife mill for fiber size manufacturing, together with a compression (pelletization) process for increased practicality in industrial processes.

Microdecortication, as that term is used herein, denotes a process for reducing the size of hemp fibers from long bast fibers, hurd, or whole hemp stalks, to a length substantially smaller than the length produced by decortication of the hemp stalks, without crushing the hemp feedstock. Microdecortication also is different from decortication by its ability to produce low particle size products from various feedstock, including bast fibers, hurd, or whole hemp stalk, whereas decortication entails separation of long bast fiber and hurd from whole stock and cannot produce short fibers having a length less than, for example, 5 cm from bast fiber, hurd, or whole stalk. As a result, an innovative approach that not only improves the mechanical properties of hemp polymer composites but also simplifies their handling, storage, and feeding in industrial machinery while minimizing environmental impact has been developed. For example, the transportation of materials of low bulk density necessitates more infrastructure, energy and efforts than the transportation of materials of high bulk density. Therefore, increasing the bulk density of materials decreases environmental impacts.

This disclosure extends to the development of hemp polymer composites, a significant advancement in sustainable material production. The development not only streamlines the process of obtaining hemp pellets, but it also paves the way for the incorporation of hemp-based components into a variety of industries. This detailed description examines the principles, processes, and components that comprise the development of hemp pellets and subsequent creation of hemp polymer composites, bringing light on its practical applications, benefits, and introducing contributions to advancing the field of sustainable materials.

In comparison to trees, industrial hemp has a significantly shorter growth and harvesting cycle, allowing for higher biomass yield per hectare annually. Industrial hemp is a source of long fibers used in applications such as ropes, twines, textiles, and non-woven fiber products. Through a decortication procedure, these long fibers are produced from the primary stalk of industrial hemp, resulting in fibers longer than 10 cm. The production of such long fibers from the industrial hemp stalk can range between 10 and 20 wt % of the primary hemp stalk processed, depending on the individual variety of industrial hemp and the method of decortication used.

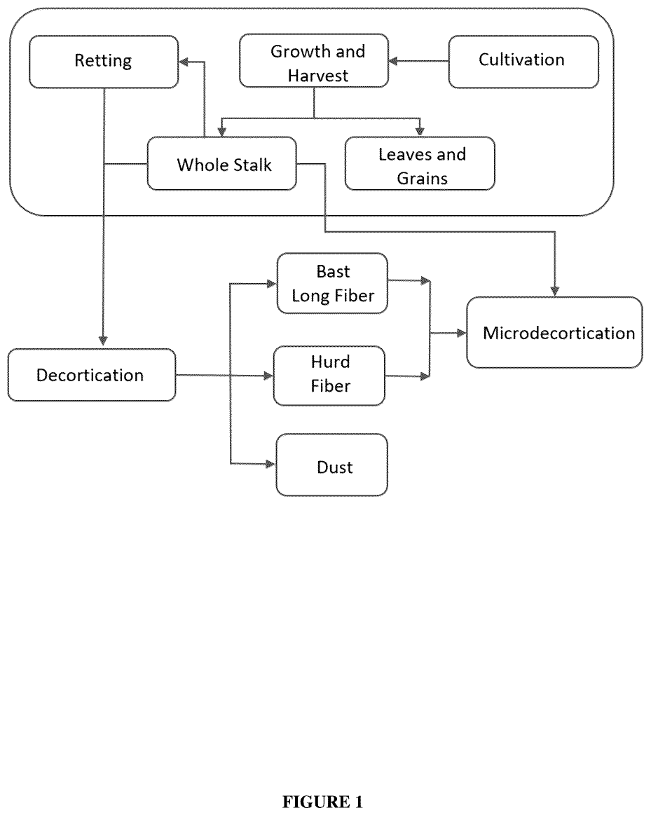

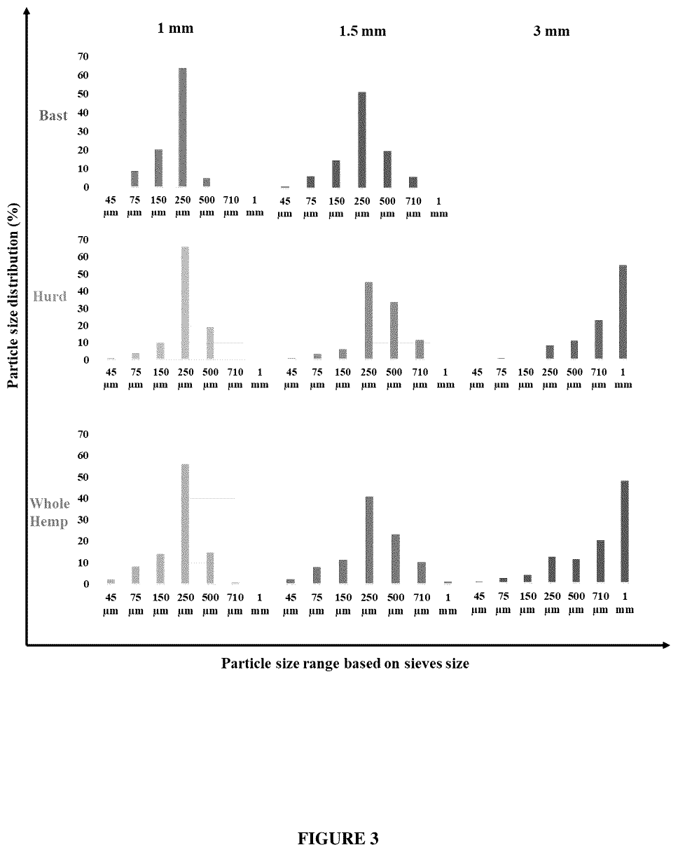

Exemplary embodiments are elucidated in the following sections with reference to tables and figures. FIGS. 1-2 and 11 provide schematic representations of preferred processes used in manufacturing densified hemp products, and hemp fiber-reinforced polymeric materials. FIGS. 3-10 provide data on hemp fiber properties, densified hemp product properties, and properties of hemp fiber-reinforced polymeric materials using varying sources of hemp, varying amounts of components, and various additives. Selecting appropriate hemp stalk, hemp fibers, hemp hurd, including their source, is typically carried out before carrying out the embodiments, which include formulation of hemp fibers, optional mixing with additives, and densification of hemp fibers using compression techniques, such as pelletization, as well as quality control of pellets.

One embodiment includes a method of densifying hemp fibers suitable for reinforcing polymeric materials, including:
a) providing a quantity of hemp stalks;
b) separating a portion of the quantity of hemp stalks to provide first and a second portions of hemp stalks;
c) subjecting a first portion of hemp stalks to decortication to produce bast fibers, hurd fibers, and dust, removing a substantial portion of dust, and separating the bast fibers and hurd fibers to produce a bast fiber portion and a hurd fiber portion. The method also includes
d) mixing the bast fiber portion, the hurd fiber portion, and the second portion of hemp stalks to provide a hemp mixture, where the hemp mixture can be made of any proportion of bast fiber portion, the hurd fiber portion, and the second portion of hemp stalks, including 100% bast fiber, or 100% of the second portion, or 100% of the hurd fiber portion;
e) microdecorticating hemp stalk or any other hemp mixture to provide a mixture of hemp fibers and particles having a length of from about 1 mm to about 20 mm, wherein the aspect ratio of the bast fibers is from about 1 to about 250, and the aspect ratio of the hurd fibers is from about 1 to about 40; and
f) compressing or densifying the mixture of hemp fibers and particles, and optional additives to form densified hemp products.

The first portion of hemp stalks that is subjected to decortication can be anywhere from about 0% to 100% of the hemp stalks, or from about 10% to about 80%, or from about 25% to about 75%, or from about 50% to 80%, or any value therebetween. The second portion of hemp stalks that is not subjected to decortication and is subjected directly to microdecortication, and can be any wherefrom about 0% to 100% of the hemp stalks, or from about 10% to about 70%, or from about 20% to about 75%, or from about 20% to 50%, or any value therebetween.

In an embodiment, the densified hemp products are in the form of compressed pellets, spheres, cylinders, or discs, and/or the quantity of hemp stalks is provided from genetic strains of the Cannabis sativa plant. In some embodiments, microdecorticating or milling the hemp mixture includes subjecting the hemp mixture to a knife mill or other particle size reduction capable of cutting fibers and having sieves or screens with openings within the range of from about 1 mm to about 5 mm. Other cutting mechanisms include shredders, blade mills, fly mills, fly cutters, and the like.

In another embodiment, compressing the mixture of hemp fibers and particles takes place in a pelletizer at a temperature within the range of from about 25° C. to about 100° C. or higher, but smaller than 200° C. An embodiment includes a pelletizer having a die opening within the range of from about 3 mm to about 5 mm or higher, but smaller than 13 mm. In an embodiment, one or more binders are added in an amount within the range of from about 0.01% to about 30% by weight of the densified hemp products during the compressing process. In addition, various additives can be added to the mixture of hemp fibers and particles to aid in the formation of suitable densified hemp products, and/or to aid in the dispersion of the densified hemp product in one or more polymers, and/or to provide desirable properties to the hemp fiber-reinforced polymeric material.

In an embodiment, one or more additives may be added to the hemp fiber mixture prior to or during densification. The additive in one embodiment is selected to fulfill different roles working on a balanced manner as a binder, lubricating agent, dispersant and compatibilizer for downstream processing. The additive can function as a binder supporting the formation of the pellet, controlling its durability and strength during its manufacturing with a pellet mill and its post-manufacturing operations like storage and transportation. The additive also may contribute to increasing the surface interaction among the particles and fibers during the compression process encountered inside the die utilized in the pelletization equipment in a manner that the additive works as a binder. The particles and fibers can be forced inside the die and subjected to increased pressure during their short residence time inside the die. The presence of the additive under such conditions promotes, among other things, controlled adhesion among the surrounding surfaces of particles and fibers thus resulting in controlled and adequate pellet strength. The action of the additive as a binder enables manufacturing pellets with sufficient durability and strength while avoiding use of excessive pressures inside the die.

The compression process that increases pressure inside a die are concepts known to those familiar with the art and the pelletization technology. While preferred embodiments discussed herein refer to a pelletizer as the compression processing technique, those skilled in the art will appreciate that other compression techniques can be employed to produce a suitable compressed hemp product of the embodiments. An excessive increase in pressure inside the die can lead to an undesirable excessive increase in temperature, undesirable excessive increase in pellet strength, and undesirable damage of the fibers for the purposes described herein. Neither very high temperature or extremely high pressures are desirable when preparing pellets of hemp short fiber for applications in thermoplastic composites because an excessive increase in temperature can lead to thermal degradation or burning of natural fibers and an extremely high pressure can lead to increasing the pellet strength to a level that can prevent, or make difficult, a proper dispersion of particles and short fibers contained in the pellet during its application in thermoplastic composites. The excessive high pressure inside the die can damage the physical integrity of the fiber causing irreversible breakage, kinks, cracks or other damage that are detrimental the using the short fiber as a reinforcement phase in thermoplastic composites.

More specifically, the strength of a pellet can be determined by binding forces, adhesion surface forces, fiber entanglement and other forces. The strength of the pellet should be such that it is judiciously controlled to enable a balance between desirable pellet durability and strength during its manufacturing, transportation, handling and storage, but allowing desirable pellet dispersion when mixing with molten thermoplastics in equipment commonly used for manufacturing plastic compounds like extruders or similar equipment.

The role of the additive as a lubricant can avoid excessive shear inside the die and temperature build up during compression. The role of the additive as a binder may contribute to create a pellet that has a certain minimum pellet strength that is sufficient to reach a desirable pellet durability index but does not have excessive pellet strength to prevent break up of pellet and dispersion of its components when mixing with molten thermoplastics in equipment commonly used for manufacturing plastic compounds like extruders or similar equipment.

The additive(s) used to prepare hemp short fiber compressed products also have a role in supporting the dispersion of the short fibers within the molten thermoplastic matrix inside the thermoplastic mixing equipment. Upon heating by the mixing equipment and action of shearing forces implied to the pellet by the molten thermoplastic resin inside the mixing equipment, the increased temperature activates the additive helping to decrease cohesive forces, breaking down of the pellet and enabling a rapid and homogeneous dispersion and distribution of particles and short fibers within the thermoplastic matrix.

Additionally, the additive(s) also have a role as a compatibilizer during manufacture of the plastic compounds. This may take place while mixing the short fibers dispersed from the pellet with the molten resin at elevated temperatures, and after that when the compounds produced thereof are cooled down. The additive may function as a compatibilizer during the mixing by improving dispersion, maintaining the short fibers dispersed during mixing, as well as preventing aggregation and agglomeration of the fibers during mixing with the molten resin and after mixing when the compound mixture is cooled down.

Desirable characteristics for suitable additives include, but are not limited to, being solid or semi-solid at room temperature, or a solid dispersion in water or an emulsion. The origins of the additives can be from petroleum or renewable sources, including petroleum products, vegetable or animal products, synthetic, semi-synthetic or natural. Although it is preferable for the additive to be solid at room temperature, it is desirable that its viscosity drops considerably upon increasing the temperature above room temperature. The additive should preferentially melt or soften significantly at temperatures between 40° C. and 90° C.

The additive should be thermally stable to at least 230° C., meaning that it will not undergo thermal decomposition when the compressed short fibers are mixed with thermoplastic resin in temperatures possibly reaching 230° C.-250° C. inside the extruder. The additive also should have a boiling point preferably above 230° C. The additive should be chemically stable and chemically inert to avoid unwanted chemical decomposition or generation of reaction by-products.

The additive can be used as a single component or as a mixture of components. The additive can be a substance like waxes, greases, fats, oils or other molecular materials displaying the characteristics and attributes described herein. Examples of desirable additives are natural, semi-synthetic, or natural waxes, fats, greases, oils, or combinations thereof.

Examples of natural waxes may include, but are not limited to, beeswax or other insect waxes like shellac, ghedda or Chinese insect waxes, wool wax or fat and greases along with other animal waxes, oils or greases or their combinations, plant waxes, oils for fats like carnauba wax, candelilla wax, sugarcane wax, Japan wax, palm wax and their related oils and fats, waxes from seeds, fruits and leaves like sunflower, soy or rose waxes and oils. Examples of synthetic waxes and oils may include, but are not limited to, polyolefin waxes like paraffins, polyethylene, polypropylene or their copolymers, crude oil-based waxes or admixtures originated from physical or chemical processes such as distillation, cracking, visbreaking, isomerization or oligomerization for example, or other chemical processes such as Fischer-Tropsch synthesis.

Synthetic or semi-synthetic additives can include families of molecular materials such as hydrocarbon, aliphatic, aromatic or unsaturated, linear, branched or cyclic, such as mineral oils, polyolefins including their copolymers, perfluorinated oligomers or polymers or other halogenated materials, materials containing amide or other nitrogen-containing groups, esters or carboxylic organic compounds, such as erucamide, oleamide, stearamide, alcohols or fatty alcohols, oxidized organic compounds, containing sulphates or phosphates groups, oximes, silicones or metal soaps, for example. The nature of the chemical composition can be such that it enables one skilled in the chemical art to devise a selection of physico-chemical characteristics to deliver a suitable balance of binder, lubricating agent, dispersant and/or compatibilizer desired for use in the embodiments described herein. Using the guidelines provided herein, those skilled in the art are capable of selecting a suitable additive or combination of additives, depending on, for example, the desired characteristics of the densified hemp products, as well as the hemp fiber-reinforced polymeric material.

Another feature of an embodiment includes a method of forming a hemp fiber-reinforced polymeric material comprising:
a) mixing the densified hemp product prepared by the method above with one or more polymers;
b) heating the mixture of densified hemp product and one or more polymers while mixing to disperse the densified hemp product into the one or more polymers and provide a substantially uniformly dispersed mixture of hemp fibers and one or more polymers;
c) and cooling the substantially uniformly dispersed mixture of hemp fibers and one or more polymers to form a hemp fiber-reinforced polymeric material.

In an embodiment, the amount of densified hemp product in the hemp fiber-reinforced polymeric material can be within the range of from about 5% to about 30% by weight or higher, but preferably lower than 70% by weight. In another embodiment, the method of forming a hemp fiber-reinforced polymeric material further includes adding one or more odor-neutralizing additives in a) and/or b) above, wherein the one or more odor-neutralizing additives is present in an amount of from about 0.5% to about 10% by weight. In some embodiments, other types of additives (e.g., antioxidants, heat stabilizers, lubricants, fire retardants, etc.) may be added. In yet another embodiment, heating is carried out at a temperature within the range of from about 120° C. to about 230° C. In yet another embodiment, one or more polymer additives can be added in a) or b) above to improve the properties of the hemp fiber-reinforced polymeric material.

Another feature of the embodiments includes a densified hemp product having a bulk density within the range of from about 0.1 to about 0.6 g/cm³, the densified hemp product comprised of:
a) bast fibers having a length of from about 1 mm to about 20 mm and an aspect ratio of from about 1 to about 250;
b) hurd fibers having a length of from about 1 mm to about 6 mm and an aspect ratio of from about 1 to about 40;
c) whole hemp stalk particles having a length of from about 1 to about 20 mm; and
d) optional additives.

In an embodiment, the amount of bast fibers ranges from about 20 to about 60% by weight of the densified hemp product, and the amount of hurd fibers ranges from about 10 to about 30% by weight, and the amount of whole hemp stalk particles ranges from about 30% to about 50% by weight.

Another feature of the embodiments includes a hemp fiber-reinforced polymeric material comprising:
a) from about 5% to about 50% by weight of the densified hemp product described above;
b) from about 50% to about 95% by weight of one or more polymers; and
c) optional additives, wherein the hemp-fiber reinforced polymer material has a flexural strength of from about 8% to about 45% higher than the flexural strength of the one or more polymers without addition of the densified hemp product, and a flexural modulus of from about 35% to about 100% higher than the flexural modulus of the one or more polymers without addition of the densified hemp product.

The densified hemp product in an embodiment includes one or more additives that are useful in assisting in the formation of suitable pellets by assisting in forming a compressed mass of hemp fibers that can be dispersed in a polymeric material when forming a polymer composite material. Some examples of suitable additives include those discussed above. The hemp fiber-reinforced polymer material in another embodiment includes one or more polymers having a melting point below about 250° C. to avoid heating the mixture of densified hemp products and selected polymer at a temperature and for a period of time that degrades the hemp fiber. Some examples of suitable polymers include one or more selected from the group consisting of polyolefins, polyamides, polyesters, polyarylene sulfides, polyetherimides, polyacetals, polyphenylene oxides, polyarylketones, polycarbonates, and mixtures and combinations thereof. These polymers are commercially available in various grades, and with various additives added thereto that can affect their respective melting temperatures, as would be appreciated by those skilled in the art.

### Providing Hemp Stalks

FIG. 1 illustrates an embodiment showing various processing stages involved in obtaining whole stalk, bast and hurd fibers from hemp in the field, from cultivation to obtaining fiber. The process can vary depending on factors like the hemp variety, and climate. The successful execution of each step should be ensured to obtain high-quality fibers for various applications. The embodiments disclosed herein is described by a new mechanical method that uses a knife mill to reduce the size of the whole stalk into different sizes of fibers. Other devices that can cut the stalk can also be used. But this method is fundamentally different from other methods using equipment that preserves the length of the fiber during particle size reduction of the whole stalk. Knife fill contains a blade with a sharp edge with capacity to cut the whole stalk into smaller fibers than the size of the initial stalk. Hammer mill, roller mill, disc mill, barrel mill and ball mill or other types of particle size reduction devices like pulverizes, crushers or grinders may not contain a blade with a sharp edge, hence the mechanism for particle size reduction in those devices is fundamentally different than in a knife mill. Hammer mill and ball mill can produce long fibers from the whole stalk, which is different from the action of a knife mill.

Other devices that can cut the whole stalk by action of sharp edge include shredders. Shredders are also devices used for size reduction. This invention is not limited to knife mill or shredders. What is fundamentally different from the other processes is that it uses equipment to cut the whole stalk or a significant part of the stalk directly into short fibers or particles.

As shown in FIG. 1, the procedure begins with the careful selection of appropriate hemp plant varieties adapted to the individual region and desired applications. The soil is typically prepared for optimal growth through techniques such as tilling and fertilizer. The planting phase begins with the planting of hemp seeds or seedlings into the prepared field. Those skilled in the art of hemp cultivation and growth are familiar with various techniques to ensure proper growth and harvesting, maximizing growing conditions in various climates, and management of appropriate hemp varieties depending on the climate.

The hemp plants are continuously monitored as they grow and develop in order to chart their journey towards maturity, which is normally reached within 3 to 4 months. Throughout this phase of growth, regular assessments are performed to detect any signs of illness, pests, or other potential problems. The industrial hemp crop is a plant with a relatively thin stem that can be harvested mechanically or manually. The stage of harvesting usually takes place when the stalks of the hemp plants have fibers of the necessary maturity level, providing the highest quality. During harvesting, the hemp leaves and grains can be removed from the whole stalk by techniques familiar to those skilled in the hemp cultivation and growth arts.

Following harvest, in one embodiment, some or all the whole stalk is subjected to a retting phase, during which the harvested hemp stalks are strategically placed in rows or bundles within the field, allowing natural factors such as dew, rain, and microbial processes to penetrate. This retting process is usually characterized by the slow partial degradation of lignin and other components in plant stalks, which may be aided by moisture and microbial activity. The retting process, which typically lasts from few to several weeks, usually entails close monitoring, with time adjusted dependent on ambient conditions and the specific quality requirements of the fibers.

### Processing the Hemp Stalks

After the retting process is completed, in an embodiment, the retted hemp stalks are gathered and compressed into bales to make them more manageable for shipping and additional processing. The hemp stalks then can be mechanically treated during a decortication phase to separate the exterior bast fibers from the inner hurd fibers. Various techniques known to those skilled in the art can be used during the decortication phase, including, for example, those disclosed in U.S. Pat. Nos. 7,669,292, and 9,487,914, and U.S. Patent Application Publication No. 2016/0130762, the disclosures of which are incorporated herein by reference in their respective entireties. Bast fibers are gathered and prepared for further processing operations, which may include the removal of contaminants such as hurd, shives and non-fibrous components using scutching and hackling processes, which are processes well known in the art (see, e.g., WO2006/030157, the disclosure of which is incorporated herein by reference in its entirety). Further processing of the inner hurd fibers includes crushing them into finer particles. Finally, depending on their intended use in subsequent manufacturing processes, the processed bast and hurd fibers are prepared for transport to processing facilities or storage, or may be processed on-site depending on the unit operations available on-site.

### Densifying the Processed Hemp

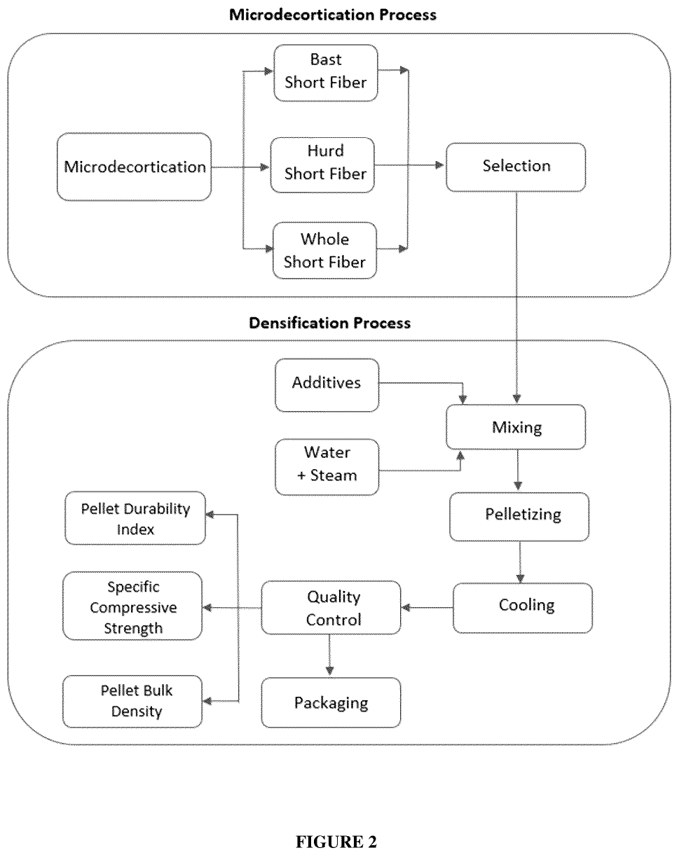

FIG. 2 provides a comprehensive overview of a hemp densification process in accordance with an embodiment, and illustrates various stages from the initial preparation of hemp fibers to the final packaging and distribution of the pellets. This embodiment includes a method of densifying hemp fibers suitable for reinforcing polymeric materials, including:
a) providing a quantity of hemp stalks optionally subjected to retting;
b) separating a portion of the quantity of hemp stalks to provide first and a second quantities of hemp stalks;
c) subjecting a first portion of hemp stalks to decortication to produce bast fibers, hurd fibers, and dust, removing a substantial portion of dust, and separating the bast fibers and hurd fibers to produce a bast fiber portion and a hurd fiber portion. The method also includes
d) mixing the bast fiber portion, the hurd fiber portion, and the second portion of hemp stalks to provide a hemp mixture in any proportion; or mixing using individual portions of bast fiber or hurd fiber or hemp stalks to provide a hemp mixture; or mixing whole stalks to produce the hemp mixture without addition of any portion produced by decortication;
e) microdecorticating the hemp mixture to provide a mixture of hemp fibers and particles having a length of from about 1 mm to about 20 mm, wherein the aspect ratio of the bast fibers is from about 1 to about 250, and the aspect ratio of the hurd fibers is from about 1 to about 40, preferably from about 1 to about 6, and optionally adding one or more additives to the milled mixture; and
f) compressing or densifying the mixture of hemp fibers and particles, and optional water and additives to form densified hemp products.

In an embodiment, the densified hemp products are in the form of compressed pellets, cylinders, spheres, discs, or pellets with other geometries and/or the quantity of hemp stalks is provided from genetic strains of the Cannabis sativa plant. In some embodiments, milling the hemp mixture includes subjecting the hemp mixture to a knife mill having sieves with openings within the range of from about 1 mm to about 5 mm.

In another embodiment, compressing the mixture of hemp fibers and particles takes place in a pelletizer at a temperature within the range of from about 25° C. to about 100° C. or higher, but smaller than 200° C. An embodiment includes a pelletizer having a die opening within the range of from about 3 mm to about 5 mm or higher, but smaller than 13 mm in diameter. In an embodiment, one or more binders and/or other additives are added in an amount within the range from about 0.01% to about 30% by weight of the densified hemp products before or during the compressing process.

In the embodiment illustrated in FIG. 2, the process commences with careful selection of hemp fibers, whole stalk, bast fiber, and hurd fiber or any combinations of these as shown in FIG. 1. The microdecortication, or milling by cutting stage follows, where a portion of the whole, dried hemp stalks that were not subjected to decortication, with or without retting, are mixed together with the bast and hurd fibers in any proportion or as individual components and introduced into the microdecortication process including use of a knife mill, shredder, blade mill, fly mill cutter, and the like. In an embodiment, a knife mill is used to microdecorticate the whole hemp stalks. Knife mills are generally known in the art as useful in grinding spices and the like, as disclosed in, for example, U.S. Pat. No. 6,585,178, WO2007/000300, the disclosures of which are incorporated herein in their respective entireties. This mechanical milling process cuts down the hemp material into smaller pieces or fibers, preparing it for the subsequent phases.

Decortication using a hammer mill, roller mill, ball mill, and/or manual beating produces dust, hurd (from millimeters to few centimeters) and long fibers (from 10 centimeter to several centimeters longer than that), which is a much larger size range than the size of the hemp particles produced during microdecortication. Microdecortication produces a narrow range of size, because the hurd and the bast fiber are both cut to produce short fiber. The size of the short fiber produced by microdecortication by cutting both the hurd and the bast fiber present in the hemp stalk can be controlled to less than 2 centimeters, or more preferably less than 1 centimeter, by selecting the type of knives and screen or processing parameters like feeding rate, equipment configuration and size.

Using microdecortication (for example using a knife mill) instead of the traditionally employed decortication via a hammer mill in the process of generating hemp fibers is advantageous when the goal is to manufacture a certain material that requires controlled particle sizes. The particle size reduction process in a standard hammer mill (or roller mill or ball mill) is essentially based on the use of rotating hammers (rollers or balls) to break, crush and pulverize the whole hemp stalk while preserving the length of the bast fiber with the expectation that such fibers are long enough to serve the purpose of its application. This produces relatively small particle sizes like hurd and dust and large particle size like long bast fiber, which may not be ideal when it comes to hemp processing adaptability when hemp short fibers are preferred. Hemp long bast fiber produced by decortication has to be long enough to enable desirable bast fiber entanglement to serve subsequent manufacturing processes. The decortication process is not designed to produce short bast fibers.

In contrast, microdecortication makes use of sharp knives to cut, slice, and shred the hemp stalk, bast fiber, or hurd fiber into small particles. This cutting operation results in a selected range of particle sizes. The particle size and the distribution of sizes produced by microdecortication creates short fibers suitable for application in reinforcement of thermoplastic resins manufactured by injection molding or extrusion molding or formation.

Microdecortication also has the advantage of allowing for more adequate control over the size of the produced hemp short fibers, and it satisfies the requirements of various applications. This versatility can be important for creating hemp pellets because it allows for better control of pellet formation and properties of the pellets and hemp-reinforced polymer materials.

Another concern when using a conventional cortication process such as a hammer mill is that the impact and crushing action could cause fiber damage. Because hammer mills subject the processed materials to significant impact forces during grinding, the formation of long bast fiber obtained may come at the expense of fiber integrity. In contrast, the cutting or dicing or slicing action of microdecortication, for example, from the edge of the blade of a knife mill, is better method to produce short fibers than that of a hammer mill, followed by size reduction. The edge of the knife cuts the fiber in specific locations, whereas the hammer mill impacts the fiber in many locations without cutting it but leaving damaged structures on the fiber that can act as weak spots during its application as reinforcing agent. The method of cutting the hemp stalk with a sharp edge knife lowers the risk of fiber damage, retaining the integrity of hemp fibers. The use of microdecortication in this context therefore enables the manufacture of high-quality short hemp fiber and hemp pellets for a variety of industrial uses.

After the microdecortication or milling process, in optional embodiments in which the now reduced sized hemp fibers are blended with other materials, such as binders or other additives, mixing is conducted to achieve a consistent and uniform mixture, thereby improving the compression/densification process and tailoring the properties of the pellets.

In the embodiment shown in FIG. 2, after the materials are mixed, they are then subjected to densification, which is depicted in FIG. 2 as a particularly preferred pelletizing process. In this particularly preferred embodiment, the mixed hemp material that was previously reduced into desired sizes (and any accompanying materials) enters a pellet mill, a machine equipped with a die and rollers. Pellet mills are generally known in the art and described in, for example, U.S. Pat. No. 10,704,196, the disclosure of which is incorporated herein by reference in its entirety. Within the pellet mill, pressure may be applied to the hemp mixture, which is forced through the die. The application of heat and water may be employed to soften the materials and facilitate binding, resulting in the formation of cylindrical hemp pellets. Once formed, the pellets are allowed to cool in the cooling stage, which aids in solidification and prepares the pellets for subsequent handling. If particle size and uniformity are important, a screening procedure can be used to separate pellets based on their dimensions, thereby removing any oversize or undersize pellets.

Quality control typically is an important part of any manufacturing process, ensuring that the hemp pellets satisfy the desired specifications of the customer or consumer. To ensure product excellence, quality inspections may include visual assessments, color, durability and moisture content tests, and other criteria evaluations. Following these examinations, the finished hemp pellets can preferably be packaged in appropriate containers, silos or bags, ready for storage, transit, or use in a variety of applications.

To densify/pelletize short hemp fibers, the fiber size preferably is decreased to a size comparable to the diameter of the die hole of the pellet mill, so that the fibers size does not contribute to the formation of fiber bundles, entanglements or bridging as they enter the die hole obstructing it. Long bast fiber cannot be pelletized because the length of the fiber is several times larger than the diameter of the die, thus formation of fiber bundles, entanglements or bridging prevents fiber from entering the die.

In this embodiment, hemp fibers can be processed in a microdecortication process, for example, using a knife mill with sieves containing different openings, and these sieves processed fibers with a selected particle size dispersion. When pelletizing, having a controlled particle size distribution is advantageous because long fibers can easily entangle and form an agglomerate, whereas short fibers with higher surface area can fill in the gaps between fiber and particles of different sizes, resulting in pellets with higher durability and density than pellets with narrow size fibers. Long bast fibers produced by decortication having lengths above 10 centimeters cannot be pelletized because they entangle and obstruct the die.

In Table 1, the Fiber Milled Size (mm) indicates the nominal size of the sieve incorporated in the microdecortication process (e.g., knife mill) to produce the fibers. Three sieve sizes were evaluated separately: 1 mm, 1.5 mm, and 3 mm. FIG. 3 illustrates the size distribution for bast, hurd, and whole fibers milled in different sizes. The examination reveals that bast fibers milled to 1 mm and 1.5 mm nominal sieve size are observed to have a significant portion of fibers in the size range of 150 μm to 500 μm, with the 1.5 mm nominal sieve size also containing a minor portion within the size range of 750 μm to 1 mm. As for hurd fibers, their size range transitions from primarily smaller fibers within the 250 μm to 500 μm size range in 1 mm milled with nominal sieve size to predominantly longer fibers within the 1 mm to 2 mm size range in 3 mm nominal size milled fibers. The sizes are fundamentally different than long fiber produced by decortication having lengths above 10 centimeters.

After the microdecortication process, whole hemp fiber, bast, and/or hurd fibers may have comparable length distributions, but they typically have quite distinct aspect ratios. Compared to hemp hurd fibers, hemp bast fibers are thinner. The quality of the densified hemp products (e.g., pellets) and hemp fiber-reinforced polymer composites may be influenced greatly by fiber attributes such as the individual fiber's aspect ratio and length.

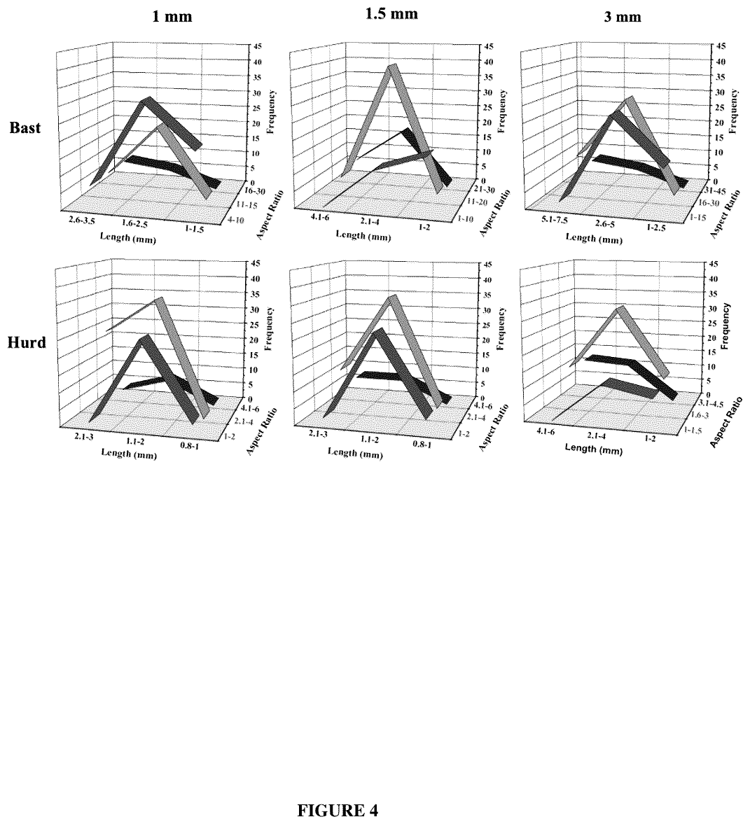

An optical microscope measurement of bast and hurd fibers microdecorticated in various sizes is shown in FIG. 4, which offers a thorough visual representation of the connection between the fibers' length distribution, aspect ratio, and frequency of occurrence. As shown in FIG. 4, the milled 1 mm-sized bast fibers (milled with 1 mm nominal sieve size) exhibited lengths spanning from 1.0 to 3.5 mm, and aspect ratios ranging from 4 to 30, with the majority falling within the range of 1.6 to 2.5 mm in length and 4 to 10 in aspect ratio. In contrast, the 1 mm-sized hurd fibers (milled with 1 mm nominal sieve size) displayed lengths ranging from 0.8 mm to 3 mm and aspect ratios between 1 and 6, with most falling within the range of 1.1 mm to 2 mm in length and 2.1 to 4 in aspect ratio. Similarly, when the bast and hurd fibers were milled to a size of 1.5 mm (milled with 1.5 mm nominal sieve size), their lengths spanned from 1 mm to 6 mm and 0.8 mm to 3 mm, respectively, with the majority falling within the range of 2 mm to 4 mm in length and 1.1 mm to 2 mm. Aspect ratios varied between 1 and 30 for bast fibers and 1 to 6 for hurd fibers, with the majority having aspect ratios ranging from 11 to 20 for bast fibers and 2.1 to 4 for hurd fibers. Finally, for fibers milled to a size of 3 mm (milled with 3 mm nominal sieve size), the lengths ranged from 1 mm to 7.5 mm for bast fibers and 1 mm to 6 mm for hurd fibers, with aspect ratios between 1 to 45 and 1 to 4.5, respectively. The majority of these fibers had lengths and aspect ratios falling within the ranges of 2.6 mm to 5 mm and 15 to 30 for bast fibers, and 2 mm to 4 mm and 1.6 to 3 for hurd fibers, respectively. Notably, a substantial disparity in aspect ratios between bast and hurd fibers was observed, primarily attributed to the significant variation in the diameters of these two fiber types.

The density of the pellets typically rises with a reduction in particle size. Finer fibers possess an increased surface area compared to coarser fibers, leading to heightened friction within the pellet mill's press channel due to this extended surface area. As a consequence of this mechanism, diminishing particle size amplifies the surface area of the fibers, intensifying the friction generated by fiber-to-fiber contact and their interaction with the pellet die hole walls. This escalation in temperature may trigger the waxes on the fiber surface and lignin to undergo a softening, culminating in enhanced wetting and interaction with adjacent fibers. The result is the production of pellets characterized by elevated mechanical properties.

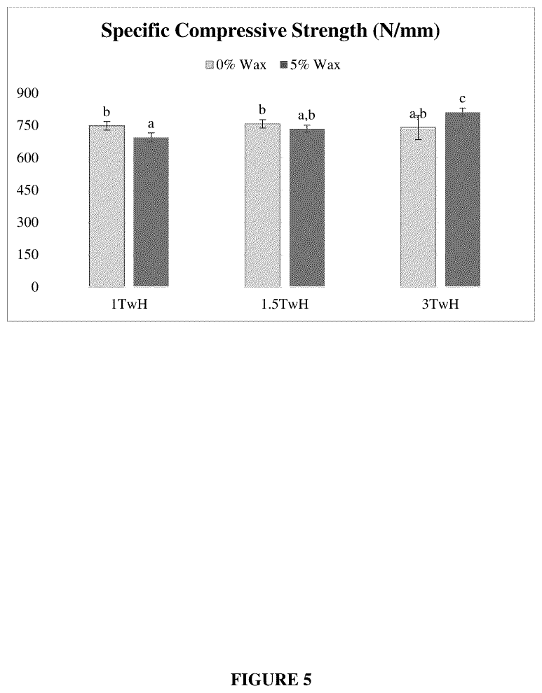

FIG. 5 illustrates the compressive strength of whole hemp pellets produced with and without 5 wt. % of additive C, containing different particle sizes. In the following example, the effect of wax additive was observed on the compressive strength of pellets prepared. Throughout the pelletization process, the temperature within the pellet mill dies and rollers may experience an elevation to approximately 60° C. or higher, primarily attributed to frictional forces. This rise in temperature is believed to soften natural fiber, causing them to conform under pressure, ultimately resulting in a lower porosity, higher interminglement among adjacent fibers thus leading to heightened pellet strength.

Samples without wax additive and crafted with fiber sizes prepared with nominal sieve size varying from 1 mm to 3 mm exhibited nearly uniform compressive strength. However, the introduction of wax significantly altered the compressive strength of these samples. The most notable increase in compressive strength, reaching 811.0 N/mm, was observed in the pellets incorporating the wax additive and 3 mm fibers (milled with 3 mm nominal sieve size). The statistical analysis of the acquired results was conducted utilizing Statsoft Statistica, version 10, employing the Tukey test for the comparison of property means at a 95% confidence level. Distinct letters across bars of FIG. 5 denote statistically significant differences (p<0.05) among means determined through the Tukey Test. Table 1 presents the compositions, characteristics, and mechanical properties of these pellets.

TABLE 1

| | Fiber | Additive | Specific | Pellet | |
|---|---|---|---|---|---|
| | Milled | C | Compressive | Durability | Pellet Bulk |
| Sample ID | Size (mm) | (wt. %) | Strength (N/mm) | Index (%) | Density (g/cm³) |
| 1TwH-0W | 1.0 | 0 | 747.5 ± 20^{b} | 95 | 0.42 ± 0.003^{d} |
| 1.5TwH-0W | 1.5 | 0 | 757.5 ± 20^{b} | 95 | 0.40 ± 0.004^{d} |
| 3TwH-0W | 3.0 | 0 | 739.6 ± 57^{a, b} | 91 | 0.27 ± 0.006^{a} |
| 1TwH-5W | 1.0 | 5 | 694.0 ± 22^{a} | 93 | 0.30 ± 0.004^{b} |
| 1.5TwH-5W | 1.5 | 5 | 734.6 ± 17^{a, b} | 89 | 0.34 ± 0.005^{c} |
| 3TwH-5W | 3.0 | 5 | 811.0 ± 19^{c} | 94 | 0.35 ± 0.003^{c} |

Mean ± standard deviation (10 repetitions for the Specific compressive strength test and 3 repetitions for the Pellet bulk density test).
Note:
average with the same letter in the same column indicates no significant difference (p < 0.05) by Tukey test

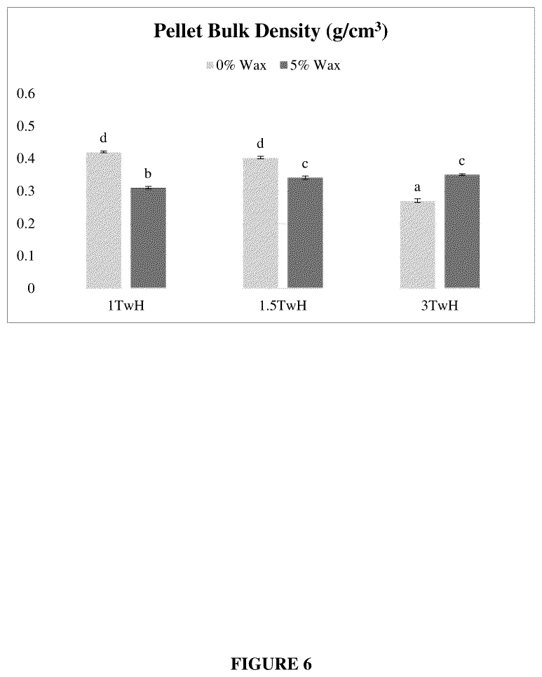

Illustrated in FIG. 6 is the bulk density of whole stalk hemp pellets prepared with 1 mm to 3 mm fibers (milled with 1 mm to 3 mm nominal sieve size) in both wax-treated and untreated pellets. Different letters across bars in FIG. 6 denote statistically significant differences (p<0.05) among means determined through the Tukey Test. It is evident that the bulk density of the pellets increased with a reduction in fiber size. The bulk density of pellets prepared with 1 mm and 1.5 mm fiber (milled with 1 mm and 1.5 mm nominal sieve size) exhibited similar values, while pellets derived from 3 mm fibers had a notably lower density. This discrepancy can be attributed to the smaller fibers effectively occupying the vacant spaces between the intertwined, larger fibers, consequently augmenting the overall density. Furthermore, the heightened surface area of these smaller fibers aids in improved moisture dispersion during the pre-pelletizing stage, ultimately enhancing fiber binding during pelletization, and, as a result, elevating the bulk density property of the pellets.

Bulk density was reduced by 29% for pellets prepared with 1 mm fibers (milled with 1 mm nominal sieve size) and by 15.6% for pellets containing 1.5 mm fibers (milled with 1.5 mm nominal sieve size), when wax was added. However, the bulk density of 3 mm fiber pellets was increased by 30% upon the addition of wax. While not intending on being bound by any theory of operation, it is believed that the wax is a dihydrogenated tallow dimethylammonium chloride which improves the flowability of fibers by reducing the friction between fibers and pellet die holes wall in pellet mill during pelletization. Improved flowability of smaller fibers reduces the increase in temperature during pelletization. Low temperature does not activate natural binding mechanism of fibers, and at lower temperatures, the bond between neighboring particles was observed to be weak. On the other hand, for 3 mm fiber pellets, it also is believed that the addition of wax reduced the fiber's resistance to flow due to their size, which resulted in better packing of the pellet, hence increasing the bulk density.

Hemp pellets using hemp hurd fibers were also examined. Hemp stem usually contains about 60-80% woody core also called hurd fibers and about 20-40% bast fibers. Bast fibers hold a prominent status due to their robustness and higher cellulose content, rendering them more valuable for industrial uses. These fibers find extensive applications in various industries, including textiles, non-woven fabrics, paper production, the manufacture of nano-cellulose, and in sectors such as automotive, construction, and geotextiles.

Hurd fibers, on the other hand, are often considered a by-product of bast fiber production, with approximately 95% of hurd fibers employed in animal litter and only 5% finding use in construction. Despite being weaker than bast fibers, hemp hurd bears a resemblance to wood, while boasting a higher cellulose content and a lower lignin content in comparison to wood. The composition of hurd fibers typically includes about 17-19% lignin, about 34-48% cellulose, about 21-25% hemicellulose, about 1-2% ash, and about 4% extractives. Although hurd fibers exhibit reduced strength when compared to bast fibers, their lower density positions them as a potential wood substitute in wood fiber-reinforced plastic composites. This exploration led to an endeavor to develop pure hurd fiber pellets; however, the pelletization of hurd fibers presents distinct challenges.

Humidity adjustment also plays a role in the pelletization process of hemp fiber by promoting fiber cohesion, reducing friction, improving flowability, and enhancing the quality of the resulting pellets. Adequate moisture content in the hemp material facilitates the binding of fibers, ensuring the formation of compact and durable pellets. It also minimizes excessive friction, preventing process inefficiencies, energy consumption, and equipment wear. Furthermore, the appropriate humidity levels enhance the material's flowability, preventing blockages and ensuring consistent pellet production. Moisture can also generate localized heat, aiding in fiber softening and bonding for well-structured pellets with superior mechanical properties. For hemp fibers, we found that an initial moisture content of about 15-35% was suitable for adequate pellet manufacturing.

Different biomass materials usually require varying moisture levels during pelletization. Excessive moisture content can lead to a degradation in pellet quality, as the pellets will undergo excessive expansion when exiting the pellet mill, partly due to the incompressible nature of water, resulting in the disruption of fiber bonds. Conversely, insufficient moisture content prevents the formation of adequate binding forces necessary for maintaining pellet structure, as capillary forces are absent. In an embodiment, the moisture content for hurd fibers in the creation of pellets at pellet die temperatures below 45° C., in an amount of less than about 50%, or less than about 45%, or less than about 40%, or less than about 30%, was insufficient to form an adequate compressed particle. It was found that a moisture content above 55%, or above 60%, or above about 65%, or from about 60-65% produced pellets, but the quality of the pellets was suboptimal. To enhance pellet quality, a small quantity of bast fibers and wax were introduced into the formulation.

### Hemp Fiber-Reinforced Polymer Materials

The incorporation of hemp pellets into the formulation of polymeric materials, such as thermoplastic resins and/or thermosetting resins represents a significant enhancement in the realm of plastic composites. This process results in composite materials with superior physical properties, when compared to the properties of the base thermoplastics used in their formation. The hemp pellets, which consist of processed hemp fibers, offer several advantages to the composite materials.

Firstly, hemp fibers, when integrated into thermoplastics, contribute to increased strength and stiffness, making the resulting composites more robust and durable. The fibers act as reinforcing agents, significantly improving the mechanical properties of the composite. This enhancement is particularly beneficial in applications where stiffness, strength and structural integrity are required. Secondly, hemp pellets can positively impact the environmental footprint of the composite. Natural fibers like hemp are renewable and biodegradable, which aligns with sustainability goals. By incorporating hemp, these composites become more eco-friendly, reducing their environmental impact compared to composites that rely solely on traditional fillers or fibers. In addition, the use of hemp pellets can enhance properties such as impact resistance, wear resistance, and deformability. This makes these composites suitable for a wide range of applications, from automotive components to construction materials and beyond.

Another feature of an embodiment includes a method of forming a hemp fiber-reinforced polymeric material comprising:
a) mixing the densified hemp product prepared by the composition and the method above with one or more polymers;
b) heating the mixture of densified hemp product and one or more polymers while melting or softening the polymer and mixing to disperse the densified hemp product into the one or more polymers and provide a substantially uniformly dispersed mixture of hemp fibers and one or more polymers;
c) and cooling the substantially uniformly dispersed mixture of hemp fibers and one or more polymers to form a hemp fiber-reinforced polymeric material.

In an embodiment, the amount of densified hemp product in the hemp fiber-reinforced polymeric material is within the range of from about 5% to about 30% by weight, but not limited to 30% by weight. In another embodiment, the method of forming a hemp fiber-reinforced polymeric material further includes adding one or more odor-neutralizing additives in a) and/or b) above, wherein the one or more odor-neutralizing additives is present in an amount of from about 0.5% to about 10% by weight. In yet another embodiment, heating is carried out at a temperature within the range of from about 120° C. to about 230° C.

Another feature of the embodiments includes a densified hemp product having a bulk density within the range of from about 0.1 to about 0.6 g/cm³, the densified hemp product comprised of:
a) bast fibers having a length of from about 1 mm or less to about 20 mm and an aspect ratio of from about 1 to about 250;
b) hurd fibers having a length of from about 1 mm or less to about 6 mm and an aspect ratio of from about 1 to about 40;
c) whole hemp stalk particles having a length of from about 1 mm or less to about 20 mm; and
d) water or optional additives.
   In an embodiment, the amount of bast fibers ranges from about 20 to about 60% by weight of the densified hemp product, and the amount of hurd fibers ranges from about 10 to about 30% by weight, and the amount of whole hemp stalk particles ranges from about 30% to about 50% by weight.

Another feature of the embodiments includes a hemp fiber-reinforced polymeric material comprising:
a) from about 5% to about 50% by weight of the densified hemp product described above;
b) from about 50% to about 95% by weight of one or more polymers; and
c) optional additives, wherein the hemp-fiber reinforced polymer material has a flexural strength of from about 8% to about 45% higher than the flexural strength of the one or more polymers, and a flexural modulus of from about 35% to about 100% higher than the flexural modulus of the one or more polymers.

The hemp fiber-reinforced polymer material in an embodiment includes one or more additives suitable for aiding in the manufacture of the hemp fiber-reinforced polymer material and/or suitable for adjusting the final desired property of the hemp fiber-reinforced polymer material. In addition, additives can be employed that insulate or isolate the hemp fibers from the effect of excess heat during melting of the polymer so as to avoid decomposition of the hemp fibers.

The polymer or polymers used to form the hemp fiber-reinforced polymeric material preferably has a melting point below about 250° C. to avoid heating the mixture of densified hemp products and selected polymer at a temperature and for a period of time that degrades the hemp fiber. Some examples of suitable polymers include one or more selected from the group consisting of polyolefins, polyamides such as Nylon 11 and 12, which have lower melting points than Nylon 6 grades, polyesters, polyphenylene oxides, acrylonitrile butadiene styrene, polyacetal, polyacrylic acid, polystyrene, polyvinyl chloride, and mixtures and combinations thereof. These polymers are commercially available in various grades, and with various additives added thereto that can affect their respective melting temperatures, as would be appreciated by those skilled in the art. Properties of various grades of polymers are available on-line at MatWeb, which includes data sheets on over 175,000 materials, or Ellis, et al., POLYMERS, A PROPERTY DATABASE, 2^{nd} Ed., CRC Press, New York, NY, 2009.

The hemp fiber-reinforced polymer material in another embodiment includes one or more polymers selected from the group consisting of polyolefins, polyamides such as Nylon 11 and 12, which have lower melting points than Nylon 6 grades, polyesters, polyphenylene oxides, acrylonitrile butadiene styrene, polyacetal, polyacrylic acid, polystyrene, polyvinyl chloride, and mixtures and combinations thereof.

The polymeric material used in the hemp fiber-reinforced polymeric material is not particularly limited. In one embodiment, the polymer matrix typically constitutes from about 30 wt. % to about 80 wt. %, in some embodiments from about 35 wt. % to about 80 wt. %, and in some embodiments, from about 40 wt. % to about 70 wt. % of the composition. Any of a variety of polymers or combinations of polymers may generally be employed in the polymer matrix. Suitable polymers may include, for instance, polyolefins (e.g., ethylene polymers, propylene polymers, etc.), polyamides (e.g., aliphatic, semi-aromatic, or aromatic polyamides), polyesters, polyphenylene oxides, acrylonitrile butadiene styrene, polyacetal, polyacrylic acid, polystyrene, polyvinyl chloride, etc., as well as blends thereof.

Aromatic polymers are particularly suitable as such polymers are generally considered “high-performance” polymers in that they have a relatively high glass transition temperature and/or high melting temperature. Such high-performance aromatic polymers can thus provide a substantial degree of heat resistance to the resulting polymer composition. For example, suitable aromatic polymers may have a glass transition temperature of about 40° C. or more, in some embodiments about 50° C. or more, and in some embodiments, from about 60° C. to about 250° C. The aromatic polymers may also have a melting temperature of about 200° C. or more, in some embodiments from about 210° C. to about 250° C., and in some embodiments, from about 220° C. to about 250° C. The glass transition and melting temperatures may be determined as is well known in the art using differential scanning calorimetry (“DSC”), such as determined by ISO Test No. 11357-2:2013 (glass transition) and 11357-3:2011 (melting).

Another suitable semi-crystalline aromatic polymer is an aromatic polyamide. Particularly suitable aromatic polyamides are those having a relatively low melting temperature, such as about 200° C. or more, and in some embodiments, from about 220° C. to about 250° C., as determined using differential scanning calorimetry according to ISO Test No. 11357. The glass transition temperature of aromatic polyamides is likewise generally from about 110° C. to about 160° C. Aromatic polyamides typically contain repeating units held together by amide linkages (NH—CO) and are synthesized through the polycondensation of dicarboxylic acids (e.g., aromatic dicarboxylic acids), diamines (e.g., aliphatic diamines), etc. For example, the aromatic polyamide may contain aromatic repeating units derived from an aromatic dicarboxylic acid, such as terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc., as well as combinations thereof. Terephthalic acid is particularly suitable. Of course, it should also be understood that other types of acid units may also be employed, such as aliphatic dicarboxylic acid units, polyfunctional carboxylic acid units, etc. The aromatic polyamide may also contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Repeating units derived from 1,9-nonanediamine and/or 2-methyl-1,8-octanediamine are particularly suitable. Of course, other diamine units may also be employed, such as alicyclic diamines, aromatic diamines, etc.

Particularly suitable polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA 10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediamide) (PA12T/1212), poly(dodecamethylene terephthalamide/caprolactam) (PA12T/6), poly(dodecamethylene terephthalamide/hexamethylene hexanediamide) (PA12T/66), and so forth. Yet other examples of suitable aromatic polyamides are described in U.S. Pat. No. 8,324,307 to Harder, et al.

Substantially amorphous polymers may also be employed that lack a distinct melting point temperature, so long as the melting temperature is below the decomposition temperature of the hemp fiber, which typically is less than about 250° C. Suitable amorphous polymers may include, for instance, polyphenylene oxide (“PPO”), aromatic polycarbonates, aromatic polyetherimides, etc. Aromatic polycarbonates, for instance, typically have a glass transition temperature of from about 130° C. to about 160° C. and contain aromatic repeating units derived from one or more aromatic diols. Particularly suitable aromatic diols are bisphenols, such as gem-bisphenols in which two phenols groups are attached to a single carbon atom of a bivalent connecting radical. Examples of such bisphenols may include, for instance, such as 4,4′-isopropylidenediphenol (“bisphenol A”), 4,4′-ethylidenediphenol, 4,4′-(4-chloro-a-methylbenzylidene)diphenol, 4,4′cyclohexylidenediphenol, 4,4 (cyclohexylmethylene)diphenol, etc., as well as combinations thereof. The aromatic diol may be reacted with a phosgene. For example, the phosgene may be a carbonyl chloride having the formula C(O)Cl₂. An alternative route to the synthesis of an aromatic polycarbonate may involve the transesterification of the aromatic diol (e.g., bisphenol) with a diphenyl carbonate.

During the manufacturing of composite products, it is common practice to combine plastics with various additives. To tailor specific properties and attributes, fillers or fibers are introduced into the formulation of plastic composites. Mineral fillers like talc, mica, or calcium carbonate are frequently incorporated to enhance the rigidity of the final product, but also increase the density of the final product. Additionally, glass fibers are utilized to further reinforce plastics, increasing both rigidity and strength. Short glass fibers, typically measuring less than 10 mm in length, are introduced into the plastic formulation using mixing equipment like extruder. When these glass fiber-infused plastics are pelletized after the extrusion, the length of the glass fibers matches or is smaller than the resulting pellets originating from extrusion.

Cellulose-based fibers derived from forestry or agricultural sources have found application as fillers or reinforcement agents in plastics. The preparation of these cellulose-based fibers involves methods like grinding, milling, as well as chemical or mechanical refining or pulping, with the choice of process dictating key attributes such as the length, aspect ratio and composition of the fibers. These particular characteristics of cellulose fibers have a direct impact on various properties of the resulting plastic composites, including density, rigidity, strength, impact resistance, wear resistance, deformability, and insulating capabilities.

Within one embodiment, this disclosure pertains to a sustainable composite product made from hemp and a method for its production. This process involves the selection of industrial hemp and the application of specific mechanical techniques before integrating it with polymers.

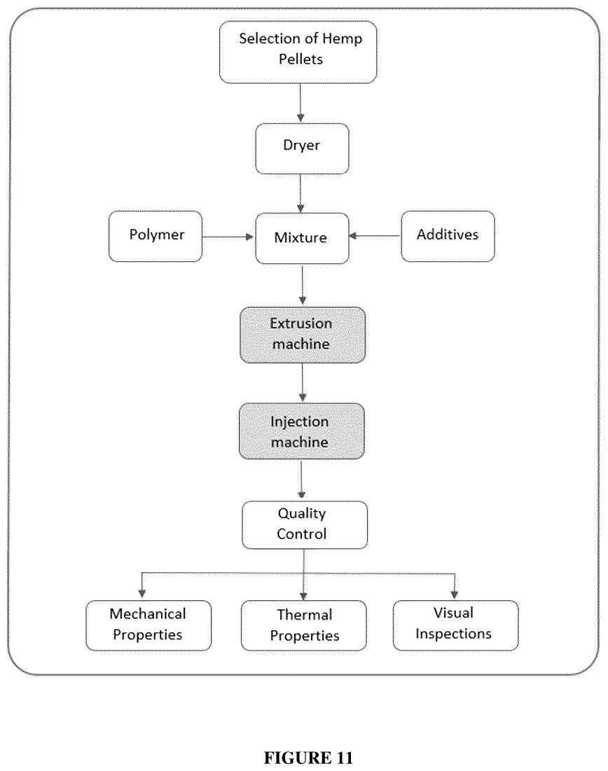

FIG. 11 is a schematic representation of the procedural steps useful in the production of thermoplastic composites. The production of hemp polymer composites involves a well-structured sequence of steps to ensure adequate results. The process commences with the careful selection of raw materials. Industrial hemp is chosen based on its specific attributes and characteristics to meet the desired composite properties. The selection may be important for achieving the targeted composite qualities, although in many instances, most commercially available hemp is suitable.

The process of selecting hemp stalk, encompassing its origin, undergoing retting or not, derived from decortication or not, its size, and composition, may play a role in determining the key attributes of hemp employed within a composite material. These attributes are multifaceted, impacting particle size, morphology, and the chemical makeup of the hemp used in the pellet formation and composite materials. Chemical composition characteristics may include cellulose, hemicellulose, lignin, moisture content, and a spectrum of other components.

Moreover, the selection of an appropriate hemp plant can be important since the morphology of the plant tissue, with its specific cell arrangement and geometry, can impact the orientation of cells, cell wall thickness and fibrils within the plant tissue in the cell wall. These aspects may influence the composite's composition, which, in turn, governs its mechanical and thermal properties, strength, and density and morphology, all of which play a role in the attributes of the final molded product performance and desirability. Using the guidelines provided herein, those skilled in the art will be capable of selecting an appropriate hemp product for use in forming a hemp fiber-reinforced polymer composite material.

The hemp fiber-reinforced polymer composite materials typically are prepared in a heated mixing apparatus such as an extruder. Within the extruder, the materials are heated and subjected to mechanical forces, enabling the formation of a continuous composite material. The extrusion process ensures uniform distribution of the fibers within the polymer matrix and their alignment, which significantly influences the mechanical properties and performance of the resulting composite.

The generated pellets are well-suited for utilization with established molding techniques employed within the plastics manufacturing sector. These pellets exhibit favorable dispersibility under regular plastic compounding operations like those found in extrusion, with desirable flow characteristics, facilitating their suitability for compression molding or injection molding processes, with cycle times ideally maintained under one minute. Following the injection process, the composite material takes its final form as a product that aligns with the intended application. The versatility of hemp polymer composites allows for a wide range of products, from automotive components to consumer goods and more.

Quality control measures are important throughout the densified hemp pellet production process. Regular inspections and assessments are conducted to confirm that the composite material and final products meet the pre-defined requirements. These checks include visual inspections, mechanical testing, and evaluations of properties such as color, strength, durability, and dimensional accuracy. In the exemplary scenario presented below, the formulations are explicated, utilizing polypropylene as the foundational material. The composition of the densified hemp product used to reinforce the polymer influences both the environmental impact and the performance characteristics of the product. The preferred formulations, while not confined to a singular configuration, center on the incorporation of a minimum of 80% environmentally sustainable ingredients within the densified hemp product, with a cap of no more than 20% reserved for additional components aimed at further enhancing diverse product attributes. These supplementary constituents may encompass, but are not restricted to, bolstering thermal stability, improving dispersion of fiber, controlling color and odor, optimizing plastic flow during molding, fortifying the strength of plastic products, and augmenting aesthetic qualities.

All the raw materials, including the densified hemp products and any polymers are dried to attain an ideal moisture content below 5 wt. %. Proper drying ensures consistent and high-quality composite materials. In this phase, the dried hemp fibers are intimately combined with selected polymers and any required additives. The blending process is undertaken with precision to create a homogenous mixture that is conducive to the subsequent processing steps.

The hemp plastic composite technology utilized in this context employs extrusion equipment, such as a twin-screw extruder or equivalent polymer mixing machines, for the purpose of mixing densified hemp pellet, additives and thermoplastic pellets, followed melting of thermoplastic, shear mixing with densified hemp pellet and additives, homogenous dispersion of all phases, thus culminating in ingredient amalgamation. This equipment may function in a continuous or batch mode. In one embodiment, the fusion and blending process is accomplished through the utilization of a twin-screw extruder, yielding a composite pellet composed of thermoplastic, hemp fiber, and additives.

A feature to consider in ensuring adequate hemp fiber-reinforced polymer composite performance is the dispersion of fibers, which can be enhanced by judicious selection of type of fiber, controlled pellet strength, or through the incorporation additives like specific waxes and lubricants aimed at ameliorating pellet disintegration while mixing with polymer leading to homogeneous fiber distribution. Small amounts of disintegrating agents may be incorporated into the densified hemp products that assist in breaking up the densified hemp products during the heating and mixing stages, and assist in adequately dispersing the hemp particles throughout the polymeric material.

The densified hemp products (pellets) exhibit sufficient thermal stability to withstand temperatures up to 230° C. without undergoing thermal degradation during compounding extrusion, or optionally up to 250° C. for a short period of time. These hemp pellets are prepared to possess specific particle dimensions and shapes, ensuring their compatibility with extrusion equipment, while avoiding an excessive increase in the molten plastic mixture's viscosity that could surpass the equipment's processing capacity. After the softening or melting and amalgamation of thermoplastics, hemp pellets, and additives, the resulting material may be pelletized or formed into any suitable shape or size for the ultimate end use of the hemp fiber-reinforced polymer composite material (e.g., injection molding, compression molding, sheet extrusion, etc.)

The incorporation of hemp pellets can be executed at varying proportions, typically falling within the range of approximately 5% to about 30% by weight, with the potential to extend up to 50% of the final material's weight. The selection of the specific quantity of short hemp fiber will vary depending upon the industrial applications of the desirable end product, such as automotive, construction materials, or outdoor usages, and the intended operating conditions, encompassing environmental factors such as temperature, humidity, and sunlight exposure. As an instance, within the automotive sector, divergent percentages may be adopted for interior or exterior applications within automobiles; similarly, within the furniture sector divergent percentages may be adopted for indoor or and outdoor applications of furniture.

Noteworthy additives that are optionally added, but are not limited to, include coupling agents, sizing, compatibilizers, waxes, heat stabilizers, antioxidants, color, pigments, flame retardants and lubricants. The employment of a compatibilizer that fosters interfacial adhesion between hemp fibers and the polymer matrix enhances the mechanical properties, bolstering stiffness and strength. Factors influencing the interfacial bonding efficacy entail atomic arrangement, chemical characteristics, molecular conformation, and chemical constitution.

While the embodiments have been described with reference to certain preferred materials, amounts, and the like, those skilled in the art will appreciate that various modifications may be made to the embodiments without departing from the spirit and scope of the embodiments. Certain preferred embodiments are described in the non-limiting examples below.

### EXAMPLES

### Example 1—Preparing Pellets with Varying Amounts of Bast and Hurd Short Fibers

Pellet formulations containing different proportions of bast and hurd short fibers and their corresponding mechanical properties are presented in Table 2.

TABLE 2

| Sample | Hurd | Bast | Fiber Milled | Specific Compressive | Pellet Durability | Pellet Bulk |
|---|---|---|---|---|---|---|
| ID | (%) | (%) | Size (mm) | Strength (N/mm) | Index (%) | Density (g/cm³) |
| H1 | 100 | 0 | 1.5 | 11 ± 2.6^{a} | 48 | 0.143 ± 0.002^{c} |
| H2 | 90 | 10 | 1.5 | 171 ± 34^{b} | 62 | 0.114 ± 0.004^{a} |
| H3 | 85 | 15 | 1.5 | 315 ± 32^{c} | 65 | 0.143 ± 0.005^{c} |
| H4 | 90 | 10 | 50% 1.5, | 436 ± 39^{d} | 55 | 0.133 ± 0.002^{b} |
| | | | 50% 1.0 | | | |

Mean ± standard deviation (10 repetitions for the specific compressive strength test and 3 repetitions for the Pellet bulk density test).
Note:
average with the same letter in the same column indicates no significant difference (p < 0.05) by Tukey test.

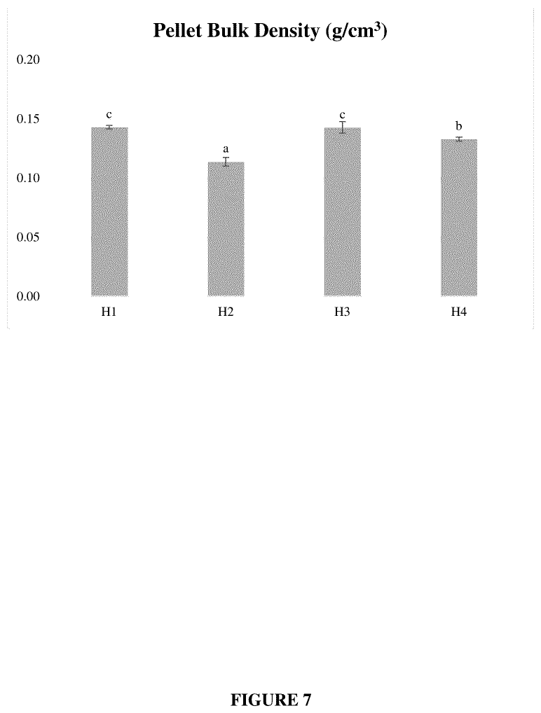

FIG. 7 depicts the bulk density of hurd pellets. Different lower-case letters in FIG. 7 indicate statistically significant differences (p<0.05) among means obtained using the Tukey Test. The bulk density of the pellets was observed to be significantly lower when compared to the density of a single hemp pellets. The presence of limited empty spaces in pellets, or increase in porosity, lowers their density. The addition of bast fiber and the increase in additive concentration exhibited little effect on bulk density, leading to the believe that the moisture content has a more dominant impact on bulk density than the effect of the pellet fiber composition or the use of additives.

The inventors discovered that the strength and durability of hurd pellets were inferior to those of whole hemp pellets. Although the discovery that whole hemp fibers are of suitable desirability, the introduction of a modest quantity of bast fibers yielded an enhancement in the mechanical properties of hurd pellets. Varying the amounts of hemp bast and hurd fibers resulted in the following, bearing in mind that the objective was to establish conditions that facilitated the smooth passage of the mixture through the pellet mill die, ultimately yielding pellets endowed with commendable mechanical characteristics and high durability.

Both 100% bast and 100% hurd fibers were difficult to flow through the pellet machine, as bast fibers due to their high mechanical interlocking and high cohesion characteristics formed agglomerates that may be stuck between the pellet mill die and roller thus obstructing or blocking the roller from moving. On the other hand, hurd short fibers have poor mechanical interlocking, poor cohesion, and brittle characteristics, which resulted in difficult pellet formation. It was discovered that temperature had a dominant effect on the mechanical properties, along with moisture. Accordingly, pellets were prepared with initial biomass moisture content between 15-35% and the temperature of pellet mill die was maintained between 50-60° C. As there was no temperature regulator on pellet mill, the temperature can be increased by operating the pellet mill initially without adding any fibers in it. Once the temperature was higher than 50° C., fibers were added. The temperature on the surface of the die and pellets was measured with a handheld infrared thermometer device. Water was sprayed to prevent temperature raising above 60° C. when needed.

### Example 2—Preparing Pellets with Different Types of Hemp

Table 3 provides the mechanical properties of pellets prepared from fibers provided by different suppliers and in using different composition of hemp bast short fibers and hurd short fibers. The fibers were milled to about 1.5 mm (milled with 1.5 mm nominal sieve size), and the initial moisture content was from about 15-35%. Table 4 contains supplier specifications on the types of hemp used to produce pellets.

TABLE 3

| | | | | | Pellet | |
|---|---|---|---|---|---|---|
| | Fiber | Hurd | Bast | Specific Compressive | Durability | Pellet Bulk |
| Sample ID | Type | (%) | (%) | Strength (N/mm) | Index % | Density (g/cm³) |
| 100H | VB.B, | 100 | 0 | 720 ± 31^{c, d} | 86 | 0.15 ± 0.002^{a} |
| 80H, 20B | T.H | 80 | 20 | 671 ± 28^{b} | 77 | 0.21 ± 0.002^{b} |
| 60H, 40B | | 60 | 40 | 666 ± 19^{a, b} | 86 | 0.23 ± 0.002^{b} |
| 40H, 60B | | 40 | 60 | 626 ± 19^{a} | 86 | 0.17 ± 0.005^{a} |
| 20H, 80B | | 20 | 80 | 742 ± 27^{d, e} | 97 | 0.41 ± 0.002^{f} |
| 100B | | 0 | 100 | 760 ± 23^{e} | 97 | 0.30 ± 0.007^{d} |
| 100H | I.B, | 100 | 0 | 741 ± 29^{d, e} | 86 | 0.32 ± 0.006^{e} |
| 80H, 20B | I.H | 80 | 20 | 696 ± 19^{b, c} | 90 | 0.27 ± 0.004^{c} |
| 60H, 40B | | 60 | 40 | 706 ± 25^{b, c, d} | 91 | 0.30 ± 0.008^{d, e} |
| 40H, 60B | | 40 | 60 | 734 ± 22^{c, d, e} | 95 | 0.28 ± 0.006^{c, d} |
| 20H, 80B | | 20 | 80 | 860 ± 16^{f} | 98 | 0.43 ± 0.001^{f} |
| 100B | | 0 | 100 | 921 ± 17^{g} | 99 | 0.52 ± 0.02^{g} |

Mean ± standard deviation (10 repetitions for the specific compressive strength test and 3 repetitions for the Pellet bulk density test).
Note:
different letters in the same column represent significant differences (p < 0.05) between the means obtained through the Tukey Test.

TABLE 4

| Supplier ID | Description | Fiber Type | Genetic Type |
|---|---|---|---|
| A | I.B | Bast | X-59, Finola |
| A | I.H | Hurd | X-59, Finola |
| B | VB.B | Bast | Anka |
| C | T.H | Hurd | Puma |

The overall specific compressive strength of pellets experienced a notable upturn as the concentration of bast fibers increased. The mechanical attributes of hurd short fiber pellets displayed substantial enhancement when a range of moisture content (ranging from 15% to 35%) and higher temperatures (50-60° C.) were employed. This led to the discovery that in the pelletization of hurd short fibers, temperature exerts a more significant influence on the mechanical properties along with moisture content. Furthermore, it was observed that hurd fiber pellets manufactured with materials from different suppliers exhibited similar specific compressive strength. In contrast, the bast fiber pellets from Supplier A demonstrated significantly greater strength compared to bast fiber pellets from Supplier B. In the table above, J.B, and J.H, denote Supplier A—Bast fibers and Supplier A—Hurd fibers, and VB.B (Supplier B—Bast fibers), T.H denote Supplier C—Hurd fibers.

The durability of all pellets was significantly high. The durability is classified as high when it exceeds 80% and moderate when the Pellet Durability Index (PDI) falls within the range of 70-80%. Pellet durability index (PDI) was determined according to ISO 17831-1 using a tumbling machine equipped with a dust-tight testing box with a stainless-steel baffle to mix the pellets. The testing box inner dimensions were 300 mm width, 300 mm height and 125 mm depth, and the mixing baffle dimensions were 230 mm length and width 50 mm. The test was performed at 60 rpm for 10 minutes. Remarkably, in this instance, nearly all the pellets exhibited durability exceeding 80%. Furthermore, the introduction of higher concentrations of bast fibers led to an increase in pellet durability. The highest PDI, reaching 99%, was observed in the case of Supplier A—bast short fiber pellets.

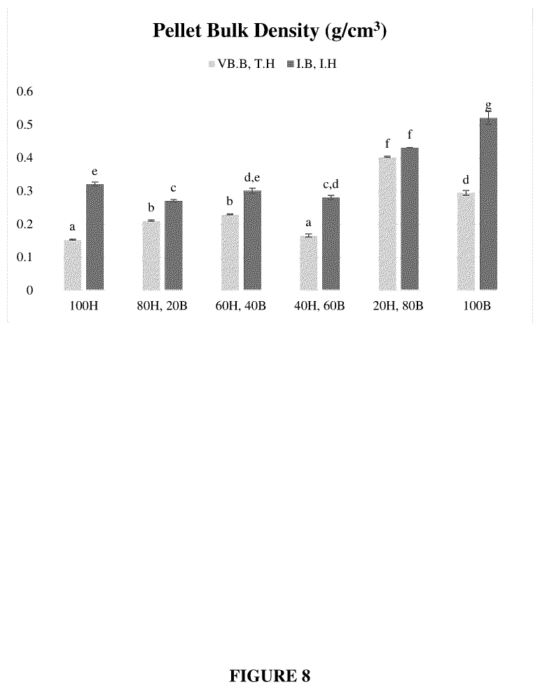

FIG. 8 illustrates the bulk density of pellets with different composition of hemp bast short fibers and hurd short fibers. Different letters throughout bars graph indicate statistically significant differences (p<0.05) among the means established using the Tukey Test. The bulk density of pellets made from Supplier A-hemp bast (I.B) and hemp hurd (I.H) fibers was notably higher than that of pellets containing Supplier B—bast fibers (VB.B) and Supplier C—hurd fibers (T.H). Interestingly, for Supplier A-Hemp fiber pellets, the bulk density exhibited a slight reduction upon the addition of 20% and 60% bast short fibers but experienced a significant increase for pellets with 80% and 100% bast short fiber content. This surge in bulk density with higher bast fiber concentration is believed to be attributed to improved mechanical interlocking, resulting from increased fiber entanglements, leading to denser and stronger pellets. Furthermore, it is also believed that temperature played a role in promoting bond formation by softening the waxes and lignin, thus allowing the fiber to confirm with each other favoring bonding contributing to pellet durability and strength. These bonding mechanisms may explain why bast short fiber pellets surpass other formulations of hurd short fiber or bast short fiber pellets in terms of strength and density. Bast short fiber pellet diameter was smaller than the diameter of the pellet dies, while both whole hemp short fiber and hurd short fiber pellets had diameters larger than the diameter of the die. This suggests that the bast short fiber pellets did not undergo significant expansion after exiting the pellet mill die.

### Example 3—Varying Hemp Particle Size

Particle size analysis of 1-, 1.5- and 3-mm milled fibers (milled with 1 mm, 1.5 mm, 3 mm nominal sieve size respectively) was also carried out after pelletization to observe the change in fiber particle size, aspect ratio and morphology. We learned that it was useful to investigate the change in particle size after pelletization because the particle size and its distribution can affect the mechanical properties of composites prepared with such pellets and fiber contained within, as observed by measuring different characteristic of fibers and particles sizes before and after pelletization.

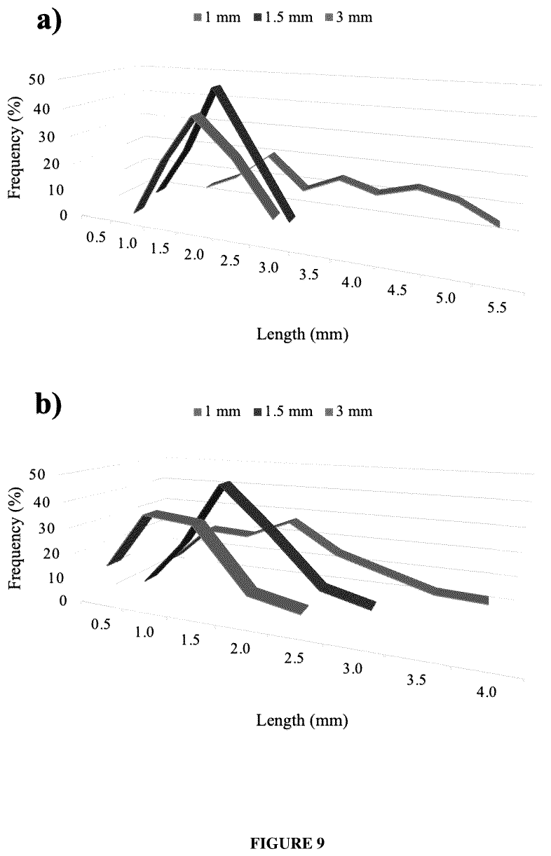

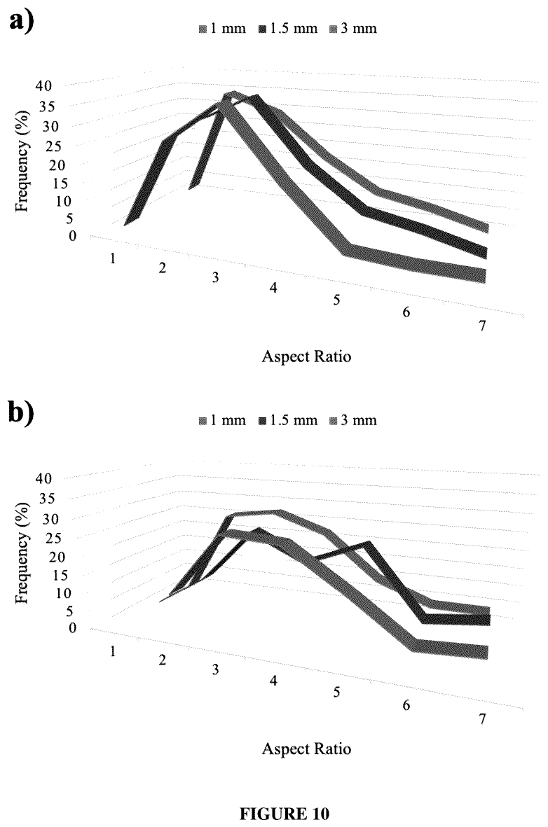

FIG. 9 represents hurd fiber lengths before and after pelletization and FIG. 10 represents their aspect ratios. We discovered that the length of hurd short fibers decreased following the pelletization process, while their aspect ratio distribution expanded. While not intending on being bound by any theory of operation, it is believed that this occurred because pelletization led to further disintegration of hurd fibers into even thinner strands, resulting in an increased aspect ratio distribution. A plausible mechanism to explain such observation is related to the shear forces acting on hurd fibers when inside the die and being subjected to high pressure, high shear, increase temperature and additional ingredients, thereby contributing to the separation into thinner fibers. All these factors are likely contributors to increasing the performance of hurd fibers upon pelletization and its utility. These discoveries suggest that hurd short fibers undergo a size transformation during pelletization, in contrast to bast short fibers, which were able to withstand the shear stresses applied during pelletization and were able to maintain their shape.

The mechanism of using shear forces to produce cellulose fibers is also found elsewhere in different applications. For instance, it is well known to those versed in the art that wood chips can be transformed in ligno-cellulosic fiber solely by mechanical means using equipment that imparts shear forces to separate the wood chips into fibers. An example of such equipment is named as high consistency refiners, which makes use of parallel discs (one rotor and one stator or other combinations) to transfer shear forces to wood chips leading to the formation of mechanical pulp fiber. Such mechanical pulp originated from trees with minimal use of chemicals is highly useful in paper products, press boards, for example, and many other mechanical pulp products.

The embodiments disclosed herein shows a fundamental mechanism related to the specific creation of a certain desired densified hemp products, where a balance of characteristics, feedstock composition, additives, temperature, moisture, die geometries and equipment specification controlling die pressure and geometries can transform hemp stalk into useful particles and fibers to enhance applications related to molded plastics or other similar molecular materials.

The observations reported herein that the aspect ratio of hurd short fiber increased after pelletization and the interpretation as a possible action of shear forces may be responsible for this mechanism is a new discovery that can provide utility and increase value of hurd short fibers, while also contributing to decreasing the environmental impact of manufactured goods and plastics. Therefore, it is considered that high shear imposed or exerted by mechanical means by judicious selection of equipment and conditions, like a pellet mill, for example, but not limited to, operating with appropriate temperature, type of plant based feedstock and moisture, or additives, will be able to create a pellet for useful applications for composites and materials manufacturing.

### Example 4—Hemp Fiber-Reinforced Polymer Materials with Additives

The following data provides an example of pellets and hemp fiber-reinforced polymeric materials manufactured with different additives. Table 5 presents the additives used for the production of pellets.

TABLE 5

| | | Softening |
|---|---|---|
| | | point |
| Additives | Family | (° C.) |
| Additive C | Dimethyl-dioctadecylammonium chloride | 30-40 |
| Additive D | Propylene/ethylene copolymer | 89-90 |
| Additive E | Propylene/ethylene copolymer | 99-103 |
| Additive F | Polyethylene wax | 120-126 |
| Additive G | Polyethylene wax | 127-132 |
| Additive H | Polypropylene wax | 155-161 |

In this example, all samples were made with polypropylene (PP) as an example of highly useful thermoplastic resign. First, a reference sample was made with 100% polypropylene (Sample 7). The other samples were prepared in a mass ratio of 75% PP, 20% hemp short fiber pellets, and 5% additives. For all formulations presented in Table 6, pellets were produced using whole hemp short fiber and particle size ranging from 0.5 to 5 mm. Flexural properties and Izod impact strength measurements on the polypropylene composite samples are presented in Table 6, and Table 7 showing characteristics of hemp short fiber filled polypropylene composites.

TABLE 6

| | | Impact energy | Flexural strength | Flexural modulus |
|---|---|---|---|---|
| Sample | Additives | (J/m) | (MPa) | (MPa) |
| 1 | Additive C | 7.40 ± 0.53 ^{b, c} | 58.40 ± 3.84 ^{c, d} | 2125.67 ± 58.48 ^{d} |
| 2 | Additive D | 7.73 ± 0.55 ^{c} | 61.10 ± 2.13 ^{d} | 1885.75 ± 84.83 ^{c, d} |
| 3 | Additive E | 7.59 ± 0.65 ^{b, c} | 49.80 ± 3.26 ^{a, b} | 1701.25 ± 124.77 ^{b, c} |
| 4 | Additive F | 7.55 ± 0.66 ^{b, c} | 53.79 ± 1.81 ^{a, b, c, d} | 1496.42 ± 56.79 ^{b} |
| 5 | Additive G | 6.59 ± 0.60 ^{a, b, c} | 52.20 ± 1.87 ^{a, b, c} | 1726.75 ± 120.99 ^{b, c} |
| 6 | Additive H | 6.09 ± 0.40 ^{a, b} | 57.60 ± 2.67 ^{b, c, d} | 1633.38 ± 76.63 ^{b, c} |
| 7 | PP (Pure) | 5.68 ± 0.45 ^{a} | 46.30 ± 4.70 ^{a} | 1093.00 ± 137.00 ^{a} |

Mean ± standard deviation (10 repetitions).
Note:
different letters in the same column represent significant differences (p < 0.05) between the means obtained through the Tukey Test.

The incorporation of 20% hemp short fiber pellets into the composite materials is evident in its positive impact on flexural strength, increasing it from 46.30 MPa (in the pure PP sample) to as high as 61.10 MPa (as observed in sample 2). This results in an improvement of approximately 31.97%. Simultaneously, there is a significant rise in the flexural modulus, with values surging from 1093 MPa to 2126 MPa when 20% hemp fibers are introduced. Notably, samples produced using additives with the lowest melting points exhibited the highest flexural modulus. When making a comparison between the pure polypropylene in sample 7 and sample 1, a remarkable 94.48% increase in the material's flexural modulus becomes apparent.

TABLE 7

| | | Tensile strength | Tensile modulus | Elongation at break |
|---|---|---|---|---|
| Sample | Additives | (MPa) | (MPa) | (%) |
| 1 | Additive C | 23.50 ± 2.03 ^{a} | 145.90 ± 16.80 ^{b} | 13.50 ± 1.08 ^{a} |
| 2 | Additive D | 26.20 ± 2.33 ^{a, b} | 145.60 ± 20.50 ^{b} | 14.80 ± 1.23 ^{a} |
| 3 | Additive E | 30.80 ± 2.04 ^{b} | 217.88 ± 17.00 ^{c} | 14.25 ± 1.28 ^{a} |
| 4 | Additive F | 29.20 ± 2.61 ^{a, b} | 285.10 ± 19.26 ^{d} | 11.80 ± 1.87 ^{a} |
| 5 | Additive G | 23.80 ± 3.10 ^{a} | 159.30 ± 10.14 ^{b} | 13.90 ± 1.37 ^{a} |
| 6 | Additive H | 28.60 ± 2.53 ^{a, b} | 157.20 ± 14.64 ^{b} | 16.25 ± 2.22 ^{a} |
| 7 | PP (Pure) | 37.30 ± 0.50 ^{c} | 83.00 ± 8.00 ^{a} | 138.20 ± 11.20 ^{b} |

Mean ± standard deviation (10 repetitions).
Note:
different letters in the same column represent significant differences (p < 0.05) between the means obtained through the Tukey Test.

The inclusion of hemp short fiber pellets had a substantial effect on the tensile modulus while notably reducing the elongation of the samples. These changes in mechanical properties can be largely attributed to the presence of natural short fibers. The results demonstrate a clear relationship between the increase in tensile modulus and the decrease in elongation. When sample 4, with 20% hemp short fiber pellet incorporation, is compared to pure polypropylene (sample 7), the Young's modulus significantly increased from 83 MPa to 285 MPa, indicating a noticeable enhancement in material stiffness.

### Example 5—Incorporation of Odor-Neutralizing Additives

Another factor to consider when processing hemp compounds is odor. Odor can be emitted when processing hemp fibers in extrusion or injection processes. Odor can be accentuated by elevated processing temperatures. When these fibers are subjected to high temperatures during such manufacturing procedures, some of the organic compounds present in the hemp fibers may undergo thermal decomposition. This decomposition releases volatile organic compounds (VOCs) that are responsible for the distinct odor.

To address possible formation of odor, an odor-neutralizing agent is introduced into the formulation. These agents are specifically designed to counteract and eliminate unpleasant odors by chemically reacting with or adsorbing the VOCs, rendering them odorless. The need for an odor-neutralizing agent is contingent on the process conditions and the desired quality of the final product. Depending on factors like the processing temperature, the type and source of hemp fibers, and the intended application of the composite material, the intensity of the odor can vary. The quantity and quality of odor is a subjective matter depending on the sensitivity of the observer.

In scenarios where the emitted odor is undesirable or detrimental to the quality of the final product or the working environment, the addition of an odor-neutralizing agent becomes important. By incorporating such agents, the formulation can effectively mitigate the odor concerns associated with processing hemp fibers, ensuring that the resulting composite material is free from unpleasant smells and suitable for its intended use.

The incorporation of fiber into matrix results in reduced impact strength as fiber tends to hinder deformation and ductile mobility of polymer molecules, which reduces the capability of composites to absorb energy during crack propagation. As an example, Table 8, below, shows results of tensile and flexural properties, and Izod impact strength from a sample processed with polypropylene and hemp pellets containing two different types of odor neutralizing additives.

TABLE 8

| | Composition | | Tensile | Tensile | Flexural | Flexural | Impact |
|---|---|---|---|---|---|---|---|
| | (wt. %) | | Modulus | Strength | Modulus | Strength | Energy |
| Sample | Additive | Additive | (MPa - | (MPa - | (MPa - | (MPa - | (J/m - |
| ID | A | B | 23° C.) | 23° C.) | 23° C.) | 23° C.) | 23° C.) |
| 1 | 0 | 1* | 1610 | 49.0 | 3080 | 63.9 | 19.5 |
| 2 | 0 | 0 | 1570 | 54.9 | 3140 | 70.3 | 21.8 |
| 3 | 0 | 1 | 1590 | 47.3 | 3130 | 61.9 | 14.3 |
| 4 | 1 | 0 | 1570 | 50.7 | 3070 | 61.8 | 19.9 |

*Additive B was added in the pellet. In the other formulations, the odor neutralizing agent was added in the extrusion process.

When contrasting the outcomes of formulations 3 and 4, which incorporate the odor-neutralizing agents B and A, respectively, with formulation 2, which contains no odor additive, a significant reduction in material impact resistance is evident. Specifically, the inclusion of additive B (formulation 3) results in a substantial decrease from 21.8 to 14.3 J/m, while the introduction of additive A (formulation 4) leads to a decrease from 21.8 to 19.9 J/m. Regarding other mechanical properties, namely tensile and flexural characteristics, minimal variations are observed upon the introduction of both odor-neutralizing agents, in comparison to the formulation lacking these additives.

Furthermore, a close correspondence in results is observed when comparing formulation 1, which integrates additive B directly into the pellet, with formulation 3, where additive B is incorporated during the extrusion process. This suggests the feasibility of directly adding the odor-neutralizing and VOC control additives to the pellet. In terms of odor, both additives effectively neutralize undesirable scents, with the injected sample exhibiting a faint chemical odor, characteristic of the additive itself.

While the embodiments have been described herein with reference to particularly preferred features and examples, those skilled in the art will appreciate that various modifications may be made without departing significantly from the spirit and scope of the embodiments.

1-20. (canceled)

21. A method of densifying hemp fibers suitable for reinforcing polymeric materials, comprising:
a) providing a quantity of hemp stalks;
b) separating a portion of the quantity of hemp stalks to provide a first and a second portion of hemp stalks;
c) subjecting the first portion of hemp stalks to decortication to produce bast fibers, hurd fibers, and dust, removing a substantial portion of dust, and separating the bast fibers and hurd fibers to produce a bast fiber portion and a hurd fiber portion;
d) subjecting the bast fiber portion, the hurd fiber portion, and the second portion of hemp stalks to microdecortication;
d) mixing the bast fiber portion, the hurd fiber portion, and the second portion of hemp stalks to provide a mixture of hemp particles and fibers having a length of from about 1 mm to about 20 mm, wherein the aspect ratio of the bast fibers is from about 1 to about 250, and the aspect ratio of the hurd fibers is from about 1 to about 40;
e) preparing the mixture of hemp particles and fibers to have a moisture content within the range of from about 10% to about 60%; and
f) compressing the mixture of mixture hemp particles and fibers, and optional additives to form a densified hemp product.

22. The method of claim 21, wherein the densified hemp product is in the form of compressed pellets, cylinders, spheres, or discs.

23. The method of claim 21, wherein the quantity of hemp stalks is provided from genetic strains of the Cannabis sativa plant.

24. The method of claim 21, wherein the microdecortication of (d) comprises subjecting the bast fiber portion, the hurd fiber portion, and the second portion of hemp stalks to a knife mill or device capable of cutting the fibers, and having a separation mechanism having openings within the range of from about 1 mm to about 10 mm.

25. The method of claim 21, compressing the mixture of hemp fibers and particles in a pelletizer at a temperature within the range of from about 25° C. to about 100° C.

26. The method of claim 21, wherein one or more binders are added in f) as additives, in an amount within the range of from about 0.01% to about 30% by weight of the densified hemp products.

27. The method of claim 25, wherein the pelletizer comprises a die having an opening within the range of from about 3 mm to about 13 mm.

28. A method of forming a hemp fiber-reinforced polymeric material comprising:
a) mixing the densified hemp product prepared by the method of claim 1 with one or more polymers;
b) heating the mixture of densified hemp product and one or more polymers while mixing to disperse the densified hemp product into the one or more polymers to provide a substantially uniformly dispersed mixture of hemp fibers and one or more polymers;
c) cooling the substantially uniformly dispersed mixture of hemp fibers and one or more polymers to form a hemp fiber-reinforced polymeric material.

29. The method of claim 28, wherein the amount of densified hemp product in the hemp fiber-reinforced polymeric material is within the range of from about 5% to about 50% by weight.

30. The method of claim 28, further comprising adding one or more odor-neutralizing additives in a) and/or b), wherein the one or more odor-neutralizing additives is present in an amount of from about 0.5% to about 10% by weight.

31. The method of claim 28, wherein heating is carried out at a temperature within the range of from about 120° C. to about 250° C.

32. A densified hemp product having a bulk density within the range of from about 0.1 to about 0.6 g/cm3, the densified hemp product comprised of:
a) bast short fibers having a length of from about 1 mm to about 20 mm and an aspect ratio of from about 1 to about 250;
b) hurd short fibers having a length of from about 1 mm to about 6 mm and an aspect ratio of from about 1 to about 40;
c) whole hemp stalk particles and short fibers having a length of from about 1 to about 20 mm; and
d) optional additives.

33. The densified hemp product according to claim 32, wherein the amount of bast fibers ranges from about 0 to about 100% by weight of the densified hemp product, and the amount of hurd fibers ranges from about 0 to about 100% by weight, and the amount of whole hemp stalk particles ranges from about 0% to about 100% by weight.

34. A hemp fiber-reinforced polymeric material comprising:
a) from about 5% to about 50% by weight of the densified hemp product of claim 32;
b) from about 50% to about 95% by weight of one or more polymers; and
c) optional additives,
wherein the hemp-fiber reinforced polymer material has a flexural strength of from about 8% to about 45% higher than the flexural strength of the one or more polymers, and a flexural modulus of from about 35% to about 100% higher than the flexural modulus of the one or more polymers.

35. A method for microdecortication of fibers selected from the group consisting of hemp fibers, bast fibers, flax, jute, kenaf, ramie, and mixtures thereof, comprising:
a) introducing feedstock whole stalk, bast fibers, and/or hurd into a cutting apparatus;
b) applying mechanical forces to the whole stalk, hurd and/or fibers within a processing cutting apparatus selected from the group consisting of a knife mill, a blade mill, a fly mill cutter, and combinations thereof, to reduce the feedstock size to a length substantially shorter than the length produced by decortication processes, while avoiding crushing of the feedstock;
c) controlling the duration of the mechanical forces applied to ensure the desired size reduction of the feedstock, while minimizing crushing or damaging the particles and/or fibers;
d) controlling the size of the short fibers produced by cutting the feedstock whole stalk, bast fibers, and/or hurd to less than 2 centimeters; and
e) selecting particles and fibers having a length of from about 1 mm to about 20 mm,
wherein the aspect ratio of the bast short fibers is from about 1 to about 250, and the aspect ratio of the hurd short fibers is from about 1 to about 40.

36. The method of claim 35, wherein the size of the short fibers produced by cutting the feedstock whole stalk, bast fibers, and/or hurd is less than about 1 cm.

37. The method of claim 35, wherein controlling the size in (d) is carried out by selecting a cutting apparatus and screen, and/or by adjustment of processing parameters selected from feeding rate, equipment configuration, and equipment size.
